(19) United States
(12) Patent Application Publication
(10) Pub. No.: US 2024/0232752 A1
(43) Pub. Date: Jul. 11, 2024

(54) SYSTEMS AND METHODS FOR IMPROVED BUILDER PROJECT MANAGEMENT

(71) Applicant: Paradigm, LLC, Middleton, WI (US)

(72) Inventors: Tim Page, Middleton, WI (US); Mickey Ristroph, Middleton, WI (US); Kari Tamminga, Middleton, WI (US); Mohammad Zagnoon, Middleton, WI (US); Travis Cogdill, Middleton, WI (US)

(21) Appl. No.: 18/409,656

(22) Filed: Jan. 10, 2024

Related U.S. Application Data
(60) Provisional application No. 63/438,175, filed on Jan. 10, 2023.

(51) Int. Cl. G06Q 10/0631; G06Q 50/08

(52) U.S. Cl. CPC G06Q 10/06313; G06Q 50/08

(57) ABSTRACT

Systems, apparatuses, methods, and computer program products are disclosed for improved builder project management. An example method includes causing presentation of a builder project management user interface. The method also includes receiving a blueprint dataset for a structure. The method also includes classifying, using a classifier model, portions of the blueprint dataset. The method also includes generating, using one or more models, digitized feature datasets for the classified portions of the blueprint dataset based on processing of the classified portions of the blueprint dataset by the one or more models. The method also includes generating, based on the digitized feature datasets, one or more material pack datasets. The method also includes causing presentation of a visual representation of the one or more material pack datasets via the builder project management UI.

### RELATED APPLICATION

The present application is a non-provisional of and claims the benefit of priority to U.S. Provisional Patent Application No. 63/438,175, filed Jan. 10, 2023, and entitled “Systems and Methods for Improved Builder Project Management”, which is incorporated by reference in its entirety.

### FIELD

Embodiments disclosed herein are related to building project management; more particularly, embodiments disclosed herein are related to management of building projects with selections of materials based on project specifications, models based on blue prints and/or builder and supplier curated information.

### BACKGROUND

Existing processes for building houses and other structures are often convoluted and difficult to manage. These processes rely on numerous different suppliers to select and provide materials for various sections of a house, leaving room for human error and potentially mismatched or missing materials. Additionally, timing as to the construction of a house may be disrupted by a variety of factors, leading to various delays and inconsistencies.

### BRIEF SUMMARY

As noted above, a builder (e.g., an individual builder, a homebuilder company, or the like) faces an enormous number of tasks to manage when building one home, let alone tens or even hundreds of homes simultaneously. For example, a builder typically send plans (e.g., blueprints or the like) out to multiple suppliers who specialize in particular areas of a structure (e.g., roofing supply, windows, doors, plumbing, etc.) and these suppliers in turn select materials based on the plans and sell or otherwise provide the materials to the builder. However, this results in a siloed process in which the builder may be unsure of the actual interoperability of (or need for) the materials until they are actually delivered to a job site. This may cause delays and/or disruptions to the construction of a home due to an insufficient number of materials being ordered, incorrect types of materials, and/or the like.

In addition to acquiring materials, another pain point builders often experience is the scheduling of deliveries in relation to their construction capabilities. For example, builders may request a specific time for delivery of certain materials based on an estimated construction schedule; however, due to unforeseen circumstances delaying the project (e.g., weather, illness, etc.), the builder may be left with little or no recourse for altering or rescheduling the delivery, thus leaving delivered materials exposed to the elements and risking the materials becoming damaged or stolen.

Further, an average house includes over one million parts and materials, and there is typically no one place to view a complete listing of all materials that make up a house. Additionally, over the course of the construction of a home, it is not uncommon for over five hundred individuals to set foot on the job site (e.g., to complete various tasks, whether it be construction, inspection, electrical/plumbing installation, etc.). Managing the scheduling of these individuals to attend to the job site is yet another challenge for a builder, and, when multiplied by tens or hundreds of job sites managed by the builder, efficiency breaks down without a central means of coordination.

A technical need therefore exists for new tools that can more efficiently facilitate the management of a multitude of builder projects while mitigating various undesirable results. Systems, apparatuses, methods, and computer program products are disclosed herein for improved builder project management via an interactive builder project management user interface (UI). Example embodiments include a builder project management system that leverages a user-friendly interactive UI to allow end users (e.g., builders, and their suppliers, subcontractors, and home-buying customers, etc.) to define various requirements and preferences for multiple and seamlessly control various aspects of the project including viewing and ordering materials, scheduling personnel and deliveries, rendering three-dimensional (3D) views of a structure from two-dimensional (2D) blueprints, and various other features described herein. Additionally, example embodiments allow for builders to acquire a clear view of all materials needed for a particular project, as well as numerous purchasing options for material packs (further described below) based on pricing information from a host of suppliers. Through the interactive interface, a more automated and effective solution to the existing complex, convoluted, and siloed processes described above is provided that makes efficient and suitable homebuilder project management available to, and accessible by, a multitude of builders. Advantageously, the interactive UI also provides insights into the statuses of various material orders via an all-in-one dashboard, enabling a builder to obtain a rich and all-encompassing view of a project's needs. Further, example embodiments of the builder project management system include automation of menial tasks and automatic generation a digitized plan of a home, allowing estimators and other personnel responsible for various aspects of the homebuilding process to save time and reduce costs.

In one example embodiment, a method is provided for improved builder project management. The method includes causing presentation, by communications hardware, of a builder project management UI. The method also includes receiving, by the communications hardware, a blueprint dataset for a structure. The method also includes classifying, by classifier circuitry and using a classifier model, portions of the blueprint dataset. The method also includes generating, by modeling circuitry and using one or more models, digitized feature datasets for the classified portions of the blueprint dataset based on processing of the classified portions of the blueprint dataset by the one or more models. The method also includes generating, by a material calculation engine and based on the digitized feature datasets, one or more material pack datasets, wherein a respective material pack dataset comprises data representing materials needed for building a portion of the structure associated with a respective digitized feature dataset. The method also includes causing presentation, by the communications hardware, of a visual representation of the one or more material pack datasets via the builder project management UI.

In another example embodiment, an apparatus is provided for improved builder project management. The apparatus includes communication hardware configured to cause presentation of a builder project management UI. The communications hardware is also configured to receive a blueprint dataset for a structure. The apparatus also includes classifier circuitry configured to classify, using a classifier model, portions of the blueprint dataset. The apparatus also includes modeling circuitry configured to generate, using one or more models, digitized feature datasets for the classified portions of the blueprint dataset based on processing of the classified portions of the blueprint dataset by the one or more models. The apparatus also includes a material calculation engine configured to generate, based on the digitized feature datasets, one or more material pack datasets, wherein a respective material pack dataset comprises data representing materials needed for building a portion of the structure associated with a respective digitized feature dataset. The communications hardware is also configured to cause presentation of a visual representation of the one or more material pack datasets via the builder project management UI.

In another example embodiment, a computer program product is provided for improved builder project management. The computer program product includes at least one non-transitory computer-readable storage medium storing software instructions that, when executed, cause an apparatus to cause presentation of a builder project management UI. The software instructions, when executed, further cause the apparatus to receive a blueprint dataset for a structure. The software instructions, when executed, further cause the apparatus to classify, using a classifier model, portions of the blueprint dataset. The software instructions, when executed, further cause the apparatus to generate, using one or more models, digitized feature datasets for the classified portions of the blueprint dataset based on processing of the classified portions of the blueprint dataset by the one or more models. The software instructions, when executed, further cause the apparatus to generate, based on the digitized feature datasets, one or more material pack datasets, wherein a respective material pack dataset comprises data representing materials needed for building a portion of the structure associated with a respective digitized feature dataset. The software instructions, when executed, further cause the apparatus to cause presentation of a visual representation of the one or more material pack datasets via the builder project management UI.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for improved builder project management.

FIG. 2 illustrates a schematic block diagram of example circuitry embodying a device that may perform various operations in accordance with some example embodiments described herein.

FIG. 3 illustrates a schematic block diagram of example circuitry embodying a device that may perform various operations in accordance with some example embodiments described herein.

FIG. 4 illustrates an example flowchart for improved builder project management, in accordance with some example embodiments described herein.

FIG. 5 illustrates an example flowchart for improved builder project management, in accordance with some example embodiments described herein.

FIG. 6 illustrates an example flowchart for generating material pack datasets, in accordance with some example embodiments described herein.

FIG. 7 illustrates an example flowchart for ordering and scheduling via a builder project management UI, in accordance with some example embodiments described herein

FIGS. 8-26 illustrate example views of a builder project management UI used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

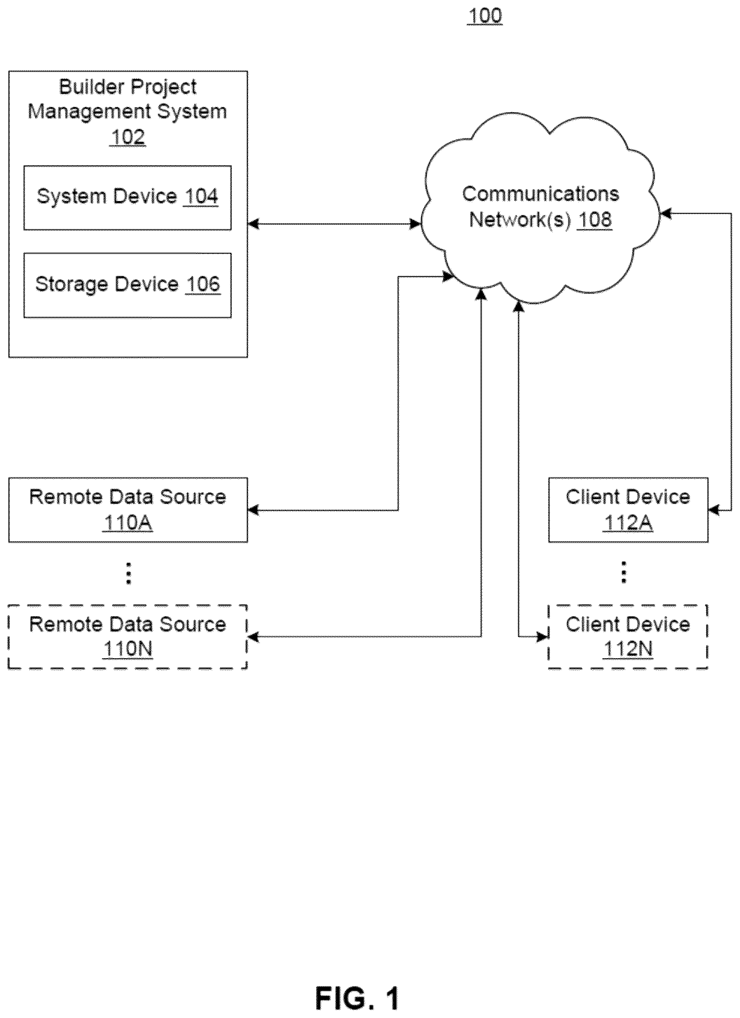

Example embodiments described herein may be implemented using any of a variety of computing devices or servers. To this end, FIG. 1 illustrates an example environment within which various embodiments may operate. As illustrated, a builder project management system 102 may include a system device 104 in communication with a storage device 106. Although system device 104 and storage device 106 are described in singular form, some embodiments may utilize more than one system device 104 and/or more than one storage device 106. Additionally, some embodiments of the builder project management system 102 may not require a storage device 106 at all. Whatever the implementation, the builder project management system 102, and its constituent system device(s) 104 and/or storage device (s) 106 may receive and/or transmit information via communications network 108 (e.g., the Internet) with any number of other devices, such as one or more of remote data sources 110A through 110N and/or one or more client devices 112A through 112N.

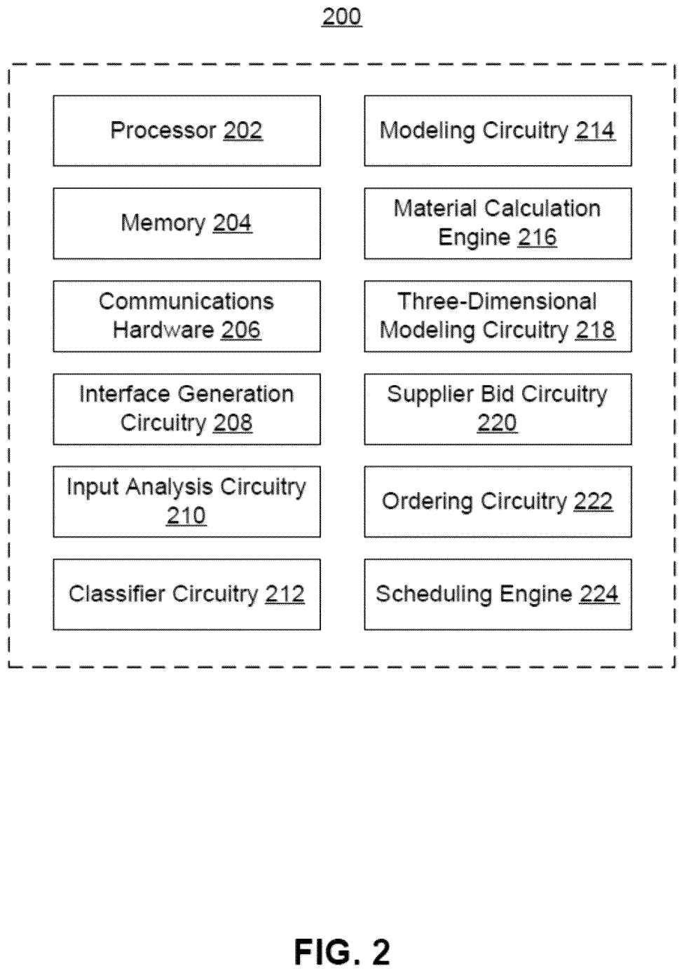

System device 104 may be implemented as one or more servers, which may or may not be physically proximate to other components of builder project management system 102. Furthermore, some components of system device 104 may be physically proximate to the other components of builder project management system 102 while other components are not. System device 104 may receive, process, generate, and transmit data, signals, and electronic information to facilitate the operations of the builder project management system 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the builder project management system 102. Storage device 106 may store information relied upon during operation of the builder project management system 102, such as various models that may be used by the builder project management system 102, data and documents (e.g., blueprint datasets) to be analyzed using the builder project management system 102, or the like. In addition, storage device 106 may store control signals, device characteristics, and access credentials enabling interaction between the builder project management system 102 and one or more of the remote data sources 110A-110N or client devices 112A-112N.

The one or more remote data sources 110A-110N may be embodied by any storage devices known in the art. Similarly, the one or more client devices 112A-112N may be embodied by any computing devices known in the art, such as desktop or laptop computers, tablet devices, smartphones, or the like. The one or more remote data sources 110A-110N and the one or more client devices 112A-112N need not themselves be independent devices, but may be peripheral devices communicatively coupled to other computing devices.

Although FIG. 1 illustrates an environment and implementation in which the builder project management system 102 interacts with one or more of remote data sources 110A-110N and/or client devices 112A-112N, in some embodiments users may directly interact with the builder project management system 102 (e.g., via input/output circuitry of system device 104), in which case a separate client device may not be utilized. Whether by way of direct interaction or via a separate client device, a user may communicate with, operate, control, modify, or otherwise interact with the builder project management system 102 to perform the various functions and achieve the various benefits described herein.

### Example Implementing Apparatuses

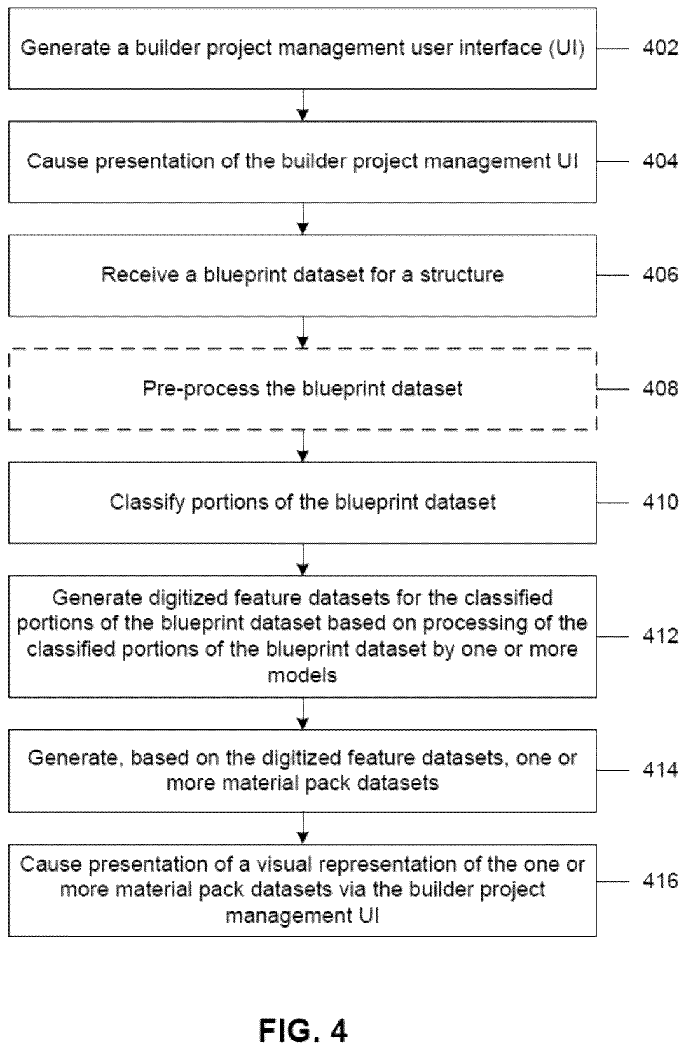

System device 104 of the builder project management system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, interface generation circuitry 208, input analysis circuitry 210, classifier circuitry 212, modeling circuitry 214, a material calculation engine 216, three-dimensional modeling circuitry 218, supplier bid circuitry 220, ordering circuitry 222, and a scheduling engine 224, each of which will be described in greater detail below. The various components illustrated in FIG. 2 may each be connected with processor 202, though in some embodiments, the apparatus 200 may further comprise a bus (not expressly shown in FIG. 2) for passing information amongst any combination of the various components of the apparatus 200. The apparatus 200 may be configured to execute various operations described above in connection with FIG. 1 and below in connection with FIGS. 4-8.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

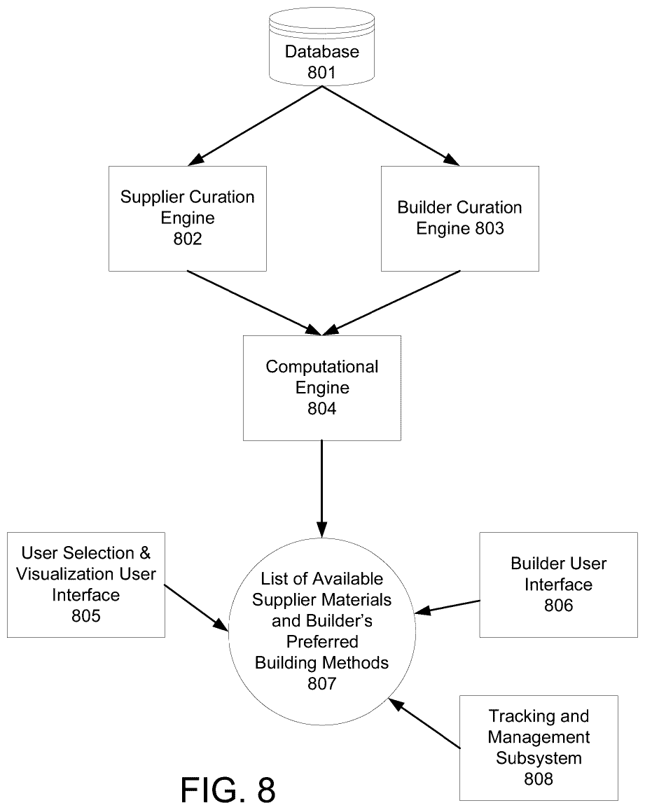

In addition, the apparatus 200 further comprises interface generation circuitry 208 that generates a builder project management user interface (UI) and other various user interfaces associated with the builder project management system 102. The interface generation circuitry 208 may utilize processor 202, memory 204, or any other hardware component included in the apparatus 200 to perform these operations, as described in connection with at least FIGS. 4-26 below. The interface generation circuitry 208 may further utilize communications hardware 206 to gather data from a variety of sources (e.g., client devices 112A-112N, remote data sources 110A-110N, and/or storage device 106, as shown in FIG. 1) and/or to receive data from a user, and in some embodiments may utilize processor 202 and/or memory 204 to configure and generate a builder project management UI and various different views within the builder project management UI, some of which are shown for example in FIGS. 8-26.

In addition, the apparatus 200 further comprises input analysis circuitry 210 that processes one or more files (e.g., a blueprint dataset) provided as input to the builder project management system 102. The input analysis circuitry 210 may utilize processor 202, memory 204, or any other hardware component included in the apparatus 200 to perform these operations, as described in connection with FIGS. 4 and 11-13 below. The input analysis circuitry 210 may further utilize communications hardware 206 to gather data from a variety of sources (e.g., client devices 112A-112N as shown in FIG. 1), and/or exchange data with a user, and in some embodiments may utilize processor 202 and/or memory 204 to pre-process a blueprint dataset, including, for example, converting a blueprint dataset from a first file format to a second file format.

In addition, the apparatus 200 further comprises classifier circuitry 212 that classifies portions of a blueprint dataset received by the builder project management system 102. To do so, the classifier circuitry 212 may include a classifier model (or multiple classifier models) trained to identify different pages or portions of a blueprint dataset. For example, the classifier model may be trained to distinguish a floorplan from an elevation diagram contained within a blueprint dataset and label the identified portions as such. The classifier circuitry 212 may utilize processor 202, memory 204, or any other hardware component included in the apparatus 200 to perform these operations, as described in connection with FIG. 4 below. The classifier circuitry 212 may further utilize communications hardware 206 to gather data from a variety of sources (e.g., storage device 106 and/or client devices 112A-112N as shown in FIG. 1), and in some embodiments may utilize processor 202 and/or memory 204 to classify a respective portion of a blueprint dataset for a structure as a respective portion of the structure.

In addition, the apparatus 200 further comprises modeling circuitry 214 that generates digitized feature datasets for classified portions of a blueprint dataset. The modeling circuitry 214 may utilize processor 202, memory 204, or any other hardware component included in the apparatus 200 to perform these operations, as described in connection with FIG. 4 below. In some embodiments, the modeling circuitry 214 may further utilize communications hardware 206 to gather data from a variety of sources (e.g., client devices 112A-112N, remote data sources 110A-110N, and/or storage device 106, as shown in FIG. 1). In some embodiments, the modeling circuitry 216 may comprise multiple models, such as machine learning (ML) models (e.g., supervised or unsupervised ML models), artificial intelligence (AI) reasoning models, and/or the like which are utilized to generate output data (e.g., digitized feature datasets comprising line and measurement data for respective portions of a blueprint dataset) based on corresponding input data (e.g., a respective classified portion of a blueprint dataset) provided to the model. In this regard, each model used may be specially trained to recognize and label features and determine measurements and sizing information for a particular portion of a blueprint dataset. For instance, one model may be specially trained to identify roofing features and may be provided a roofing diagram of the blueprint dataset. Likewise, another model may be specially trained to identify siding features and may be provided an elevation diagram of the blueprint dataset as input. The siding model may then process the elevation diagram and identify regions which would include siding along with measurements and other sizing information for the siding. Other models may be specially trained to identify and provide information on other aspects of a structure, such as doors, windows, and/or the like.

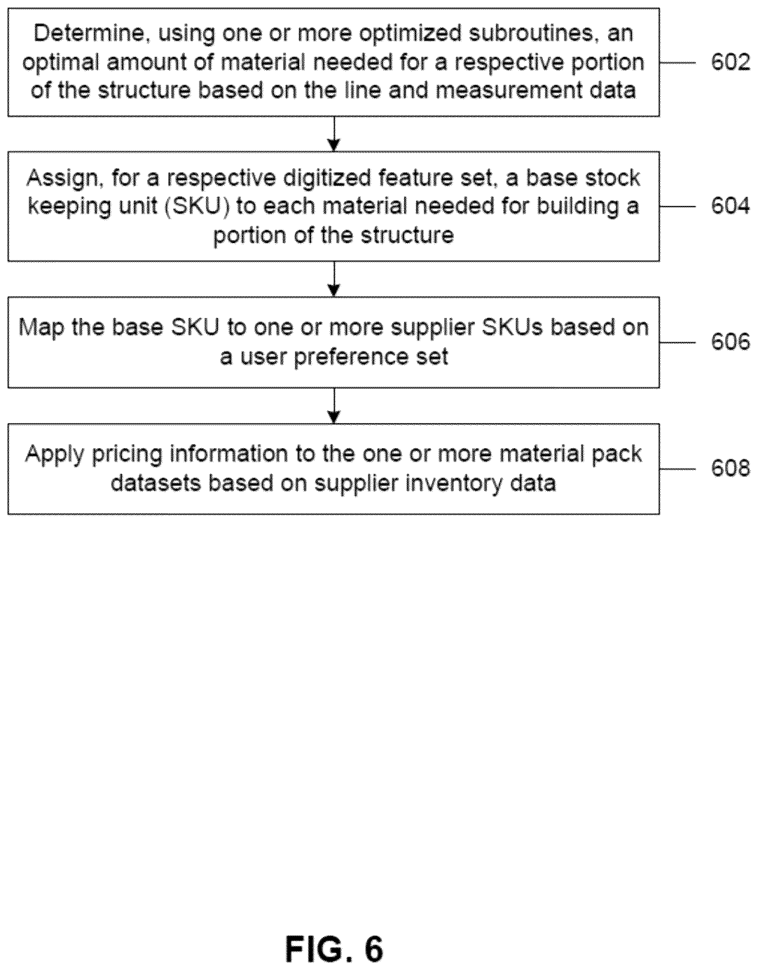

In addition, the apparatus 200 further comprises a material calculation engine 216 that generates material pack datasets based on digitized feature datasets. The material calculation engine 216 may utilize processor 202, memory 204, or any other hardware component included in the apparatus 200 to perform these operations, as described in connection with FIGS. 4 and 6 below. The material calculation engine 216 may further utilize communications hardware 206 to gather data from a variety of sources (e.g., storage device 106 and/or remote data sources 110A-110N as shown in FIG. 1), and in some embodiments may utilize processor 202 and/or memory 204 to generate material pack datasets. A material pack dataset may comprise data representing materials (e.g., all materials) needed for building a portion of the structure associated with a respective digitized feature dataset. For example, the material calculation engine 216 may generate a material pack dataset that includes data representing materials needed for building a roof based on a digitized feature dataset that includes line and measurement information for the roof. In various embodiments as described herein, the material calculation engine 216 may employ a plurality of algorithms, formulas, and the like for determining an exact number of materials needed for building a particular section of a home. Advantageously, the material calculation engine 216 may be configured to not only output an amount of material needed, but also indicate a specific use for the material. In this regard, output of the material calculation engine 216 may be logically organized, wherein certain materials are tagged for certain uses. As one example, rather than merely indicating that 180 pieces of 2×4 lumber are needed for a certain section of a house, the material calculation engine 216 may be configured to indicate that x pieces of 2×4 lumber are needed for bracing, y pieces of 2×4 lumber are needed for wall plates, etc. As further described below, the material calculation engine 216 may also be configured to map materials to supplier stock keeping units (SKUs), thereby providing a downstream shopping experience for the builder directly by way of the builder project management UI.

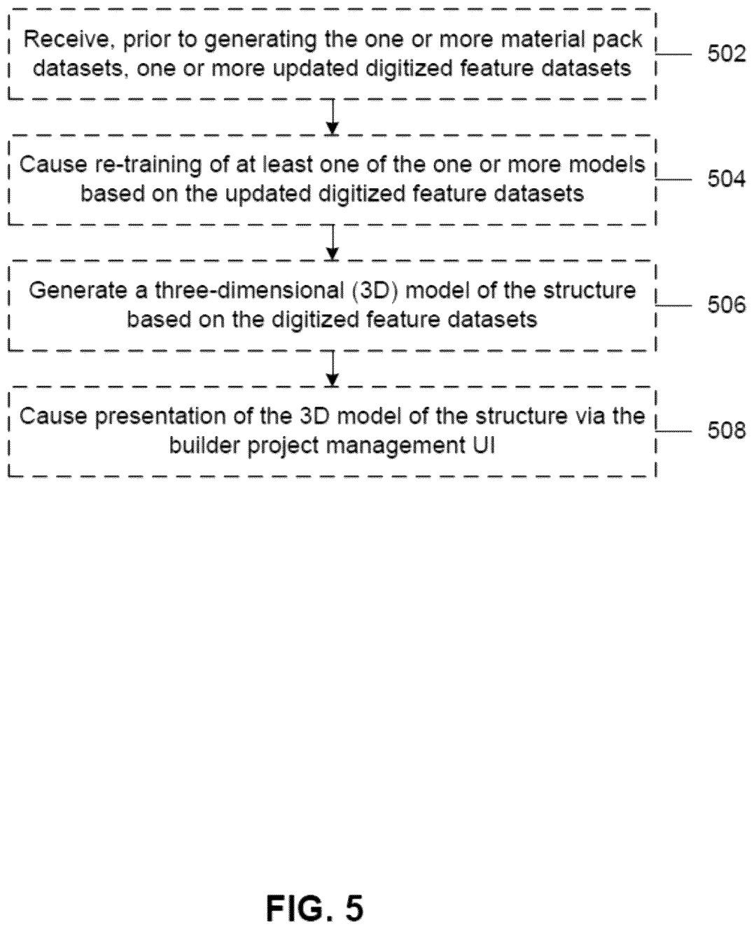

In addition, the apparatus 200 further comprises three-dimensional modeling circuitry 218 that generates a three-dimensional (3D) model of a structure based on digitized feature datasets (e.g., as generated by the modeling circuitry 214). To do so, the three-dimensional modeling circuitry 218 may include various algorithms (such as one or more machine learning techniques) that are configured to generate and render a 3D model from two-dimensional (2D) image data. The three-dimensional modeling circuitry 218 may utilize processor 202, memory 204, or any other hardware component included in the apparatus 200 to perform these operations, as described in connection with FIG. 5 below. The three-dimensional modeling circuitry 218 may further utilize communications hardware 206 to gather data from a variety of sources (e.g., storage device 106 and/or client devices 112A-112N as shown in FIG. 1), and in some embodiments may utilize processor 202 and/or memory 204 to generate a 3D model of a structure.

In addition, the apparatus 200 further comprises supplier bid circuitry 220 that retrieves and applies pricing information to material pack datasets based on supplier inventory data. The supplier bid circuitry 220 may utilize processor 202, memory 204, or any other hardware component included in the apparatus 200 to perform these operations, as described in connection with FIG. 6 below. The supplier bid circuitry 220 may further utilize communications hardware 206 to gather data from a variety of sources (e.g., remote data sources 110A-110N or storage device 106, as shown in FIG. 1), and in some embodiments may utilize processor 202 and/or memory 204 to retrieve and apply pricing information to material pack datasets. In some embodiments, the supplier bid circuitry 220 may comprise a web scraper configured to scrape supplier websites and retrieve pricing information for specific materials (e.g., based on a SKU). In some embodiments, the supplier bid circuitry 220 may be configured to store pricing information of various SKUs from various suppliers and maintain an updated record of pricing information by automatically scraping supplier websites for updated pricing information periodically. In some embodiments, the supplier bid circuitry 220 may be configured to receive pricing information transmitted to the builder project management system 102 from supplier systems. In this regard, in some embodiments, the builder project management system 102 may be configured to allow supplier systems to submit bids for material pack datasets. In other words, supplier may offer pricing on various packs of materials by way of the builder project management system 102, such that a user of the builder project management system 102 may be presented with several options of pricing for a set of materials.

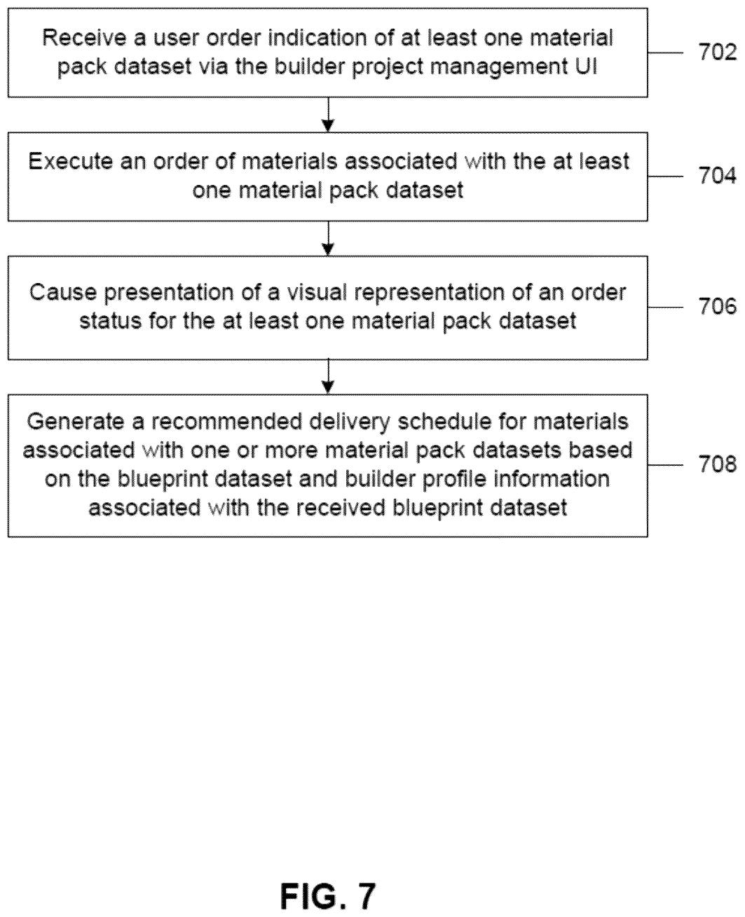

In addition, the apparatus 200 further comprises ordering circuitry 222 that executes orders of materials associated with material pack datasets. The ordering circuitry 222 may utilize processor 202, memory 204, or any other hardware component included in the apparatus 200 to perform these operations, as described in connection with FIG. 7 below. The ordering circuitry 222 may further utilize communications hardware 206 to gather data from a variety of sources (e.g., remote data sources 110A-110N or storage device 106, as shown in FIG. 1), and in some embodiments may utilize processor 202 and/or memory 204 to execute orders of materials in response to user interactions with the builder project management UI.

In addition, the apparatus 200 further comprises a scheduling engine 224 that a generates a recommended delivery schedule for materials associated with one or more material pack datasets. The scheduling engine 224 may utilize processor 202, memory 204, or any other hardware component included in the apparatus 200 to perform these operations, as described in connection with FIG. 7 below. The scheduling engine 224 may further utilize communications hardware 206 to gather data from a variety of sources (e.g., remote data sources 110A-110N, client devices 112A-112N, and/or storage device 106, as shown in FIG. 1), and in some embodiments may utilize processor 202 and/or memory 204 to generate a recommended delivery schedule and schedule deliveries based on various sources of data (further described herein).

Although components 202-224 are described in part using functional language, it will be understood that the particular implementations necessarily include the use of particular hardware. It should also be understood that certain of these components 202-224 may include similar or common hardware. For example, the interface generation circuitry 208, input analysis circuitry 210, classifier circuitry 212, modeling circuitry 214, material calculation engine 216, three-dimensional modeling circuitry 218, supplier bid circuitry 220, ordering circuitry 222, and scheduling engine 224 may each at times leverage use of the processor 202, memory 204, or communications hardware 206 such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the interface generation circuitry 208, input analysis circuitry 210, classifier circuitry 212, modeling circuitry 214, material calculation engine 216, three-dimensional modeling circuitry 218, supplier bid circuitry 220, ordering circuitry 222, and scheduling engine 224 may leverage processor 202, memory 204, communications circuitry 206, or input-output circuitry 208 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, communications circuitry 206 or input-output circuitry 208 for enabling any functions not performed by special-purpose hardware elements. In all embodiments, however, it will be understood that the interface generation circuitry 208, input analysis circuitry 210, classifier circuitry 212, modeling circuitry 214, material calculation engine 216, three-dimensional modeling circuitry 218, supplier bid circuitry 220, ordering circuitry 222, and scheduling engine 224 are implemented via particular machinery designed for performing the functions described herein in connection with such elements of apparatus 200.

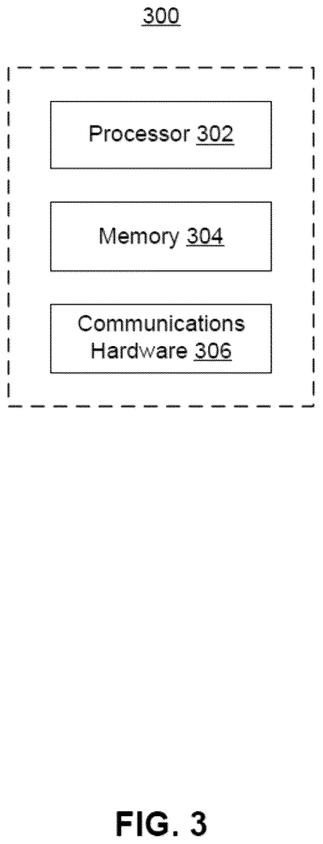

As illustrated in FIG. 3, an apparatus 300 is shown that represents an example client device (e.g., any of client devices 112A-112N). The apparatus 300 includes processor 302, memory 304, and communications hardware 306, each of which is configured to be similar to the similarly named components described above in connection with FIG. 2.

In some embodiments, various components of the apparatuses 200 and 300 may be hosted remotely (e.g., by one or more cloud servers) and thus need not physically reside on the corresponding apparatus 200 or 300. Thus, some or all of the functionality described herein may be provided by third party circuitry. For example, a given apparatus 200 or 300 may access one or more third party circuitries via any sort of networked connection that facilitates transmission of data and electronic information between the apparatus 200 or 300 and the third party circuitries. In turn, that apparatus 200 or 300 may be in remote communication with one or more of the other components describe above as comprising the apparatus 200 or 300.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts and example graphical user interfaces.

### Example Operations

Turning to FIGS. 4-8, example flowcharts are illustrated that contain example operations implemented by example embodiments described herein. The operations illustrated in FIGS. 4-8 may, for example, be performed by system device 104 of the builder project management system 102 shown in FIG. 1, which may in turn be embodied by an apparatus 200, which is shown and described in connection with FIG. 2. To perform the operations described below, the apparatus 200 may utilize one or more of processing circuitry 202, memory 204, communications hardware 206 interface generation circuitry 208, input analysis circuitry 210, classifier circuitry 212, modeling circuitry 214, material calculation engine 216, three-dimensional modeling circuitry 218, supplier bid circuitry 220, ordering circuitry 222, and scheduling engine 224, and/or any combination thereof. It will be understood that user interaction with the builder project management system 102 may occur directly via communications hardware 206, or may instead be facilitated by a separate client device (e.g., client device 112A), as shown in FIG. 1, and which may have similar or equivalent physical componentry facilitating such user interaction.

Turning first to FIG. 4, example operations are shown for improved builder project management by way of a builder project management UI. As discussed above, example embodiments herein provide a technical solution to existing issues within the realm of builder project management in the form of a builder project management system that implements a platform (e.g., a Software-as-a-Service (SaaS) platform) providing a builder project management UI with which users can easily interact to manage multiple projects, define requirements for said projects, perform ordering and scheduling tasks, and interact with various personnel such as suppliers, field crew members, company administration, and/or the like in live, real-time collaboration.

As shown by operation 402, the apparatus 200 includes means, such as processor 202, memory 204, interface generation circuitry 208, and/or the like, for generating a builder project management UI. In some embodiments, a builder project management UI may be generated (and subsequently displayed) in response to a user interaction, such as a user logging in to a website or application associated with the builder project management system 102. In this regard, as shown by operation 404, the apparatus 200 includes means, such as processor 202, memory 204, communications hardware 206, and/or the like, for causing presentation of the builder project management UI.

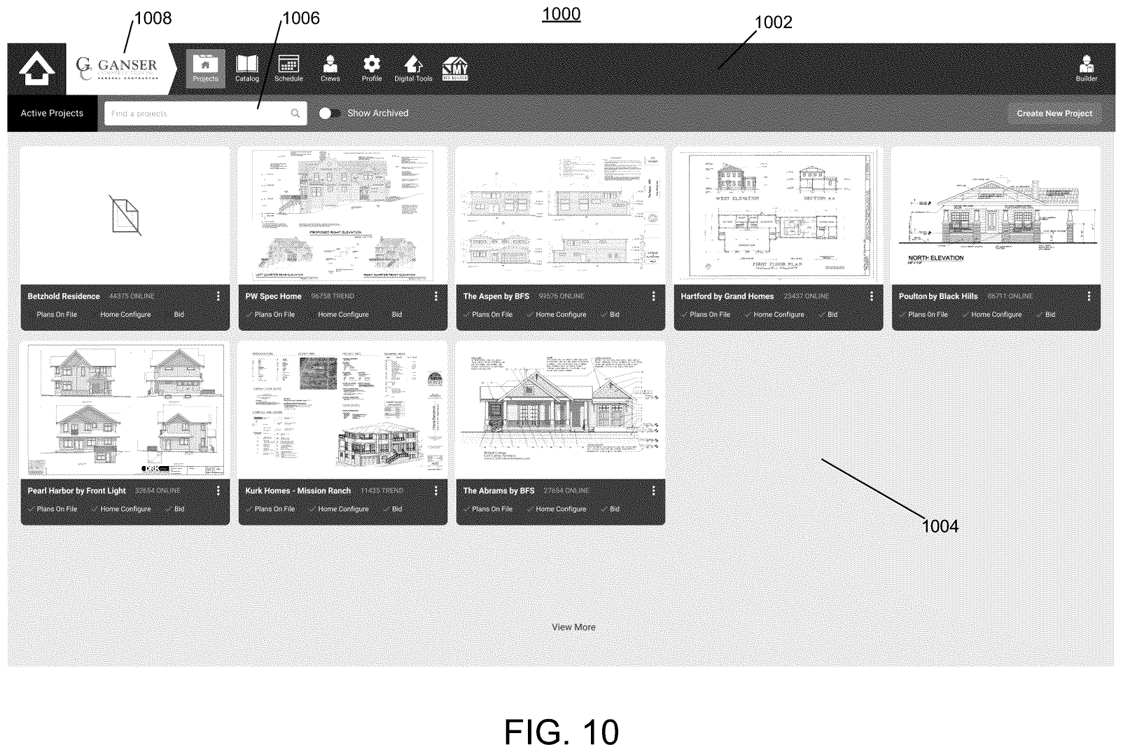

Turning briefly to FIG. 10, a graphical user interface (GUI) is provided that illustrates an example view of an example builder project management UI 1000. As noted previously, a user may interact with the builder project management system 102 by directly engaging with communications hardware 206 of an apparatus 200 comprising a system device 104 of the builder project management system 102. In such embodiments, the example builder project management UI 1000 shown in FIG. 10 may be displayed to a user by the apparatus 200. Alternatively, a user may interact with the builder project management system 102 using a separate client device (e.g., any of client devices 112A-112N, as shown in FIG. 1), which may communicate with the builder project management system 102 via communications network 108. In such an embodiment, the example builder project management UI 1000 shown in FIG. 10 may be displayed to the user by the client device.

In some embodiments, the builder project management UI 1000 may be displayed and accessed by a user via a web browser. In some embodiments, the builder project management UI 1000 may be displayed and accessed by a user via a standalone application (e.g., a desktop app, a mobile app, or the like). As shown in FIG. 8, various views of the builder project management UI 1000 may comprise a plurality of UI elements (further described below) that may include various buttons, fillable fields, selectable icons, indicators, sliders, and/or other types of user interface elements. The UI elements may be interacted with by a user via communications hardware 206 (e.g., a keyboard, mouse, etc.). In some embodiments, the UI elements may be interacted with by a user via communications hardware 306, such as a touch display (e.g., at a client device 112A, such as a mobile phone, tablet, or the like).

The example view of the builder project management UI 1000 shown in FIG. 10 includes a navigation bar 1002 that provides a plurality of selectable icons (further described herein) that allows a user to navigate to different sections of the builder project management UI 1000. The example view of the builder project management UI 1000 also includes a side bar 1004 which provides various UI elements and information depending on what view of the builder project management UI is currently being displayed. As shown in FIG. 10, the side bar 1004 provides a scrollable list of projects that are managed by the end user (e.g., a builder, and their suppliers, subcontractors, and home-buying customers, etc.) using the builder project management UI 1000. In this regard, upon logging in, a user is able to view a complete listing of projects and get started with managing various tasks associated with one or more projects. Each project in the listing may comprise a selectable button in that, once selected, causes various information associated with a selected project to be displayed. Each selectable button in the listing also contains an edit button that allows a user to edit details about the project, such as the name and address of the project, and/or other information about the project.

The builder project management UI 1000 also includes a current project indicator 1008 that displays which project is currently selected. The builder project management UI 1000 also includes a project bar 1006 which includes a selectable new project button that, when selected, allows a user to create a new project within the builder project management UI 1000. The project bar 1006 also includes a searchable field that allows a user to search for a project, which may be useful in cases in which the user manages hundreds or thousands of projects via the builder project management system 102. For example, the user may be able to search by a project name, address, or other information associated with a particular project.

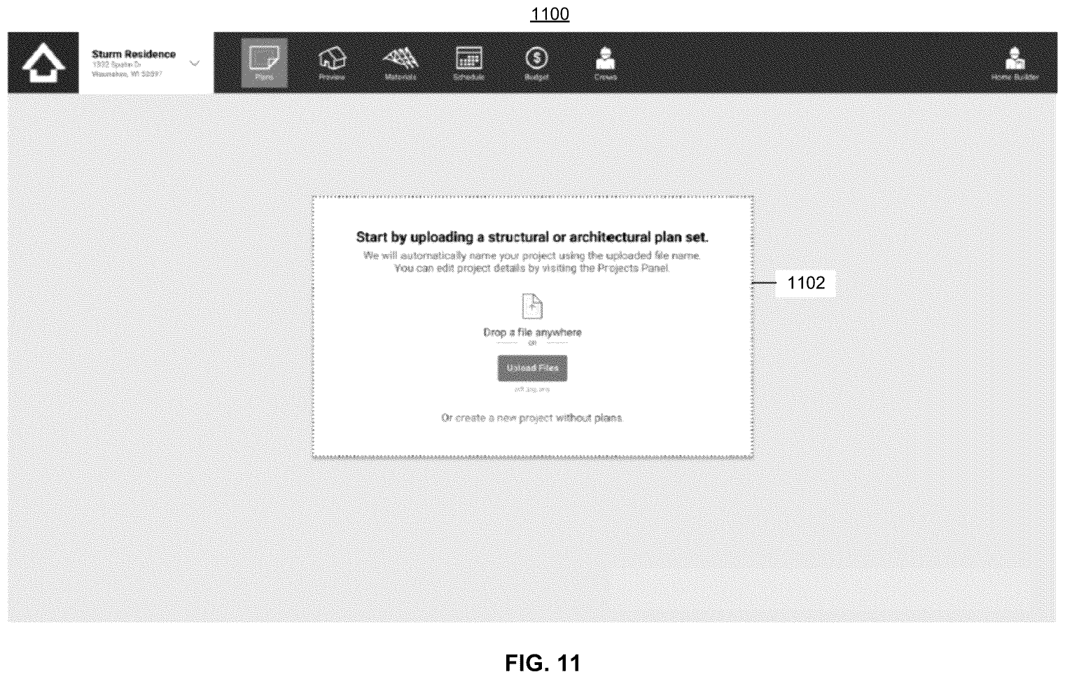

In some embodiments, when the new project button contained in the project bar 1006 is selected, another view of the builder project management UI may be displayed, illustrated for example as builder project management UI 1100 shown in FIG. 11. In some embodiments, when beginning a new project, a user may upload a blueprint dataset to the builder project management system 102. In some embodiments, a blueprint dataset comprises a digital file containing blueprint information (e.g., line information which may include labels, measurements, etc.) for a structure (such as a house, building, etc.). The digital file may be various types of files, such as spreadsheet files, Portable Document Format (PDF) documents, image files, and/or the like.

In some embodiments, a user may upload a blueprint dataset to the builder project management system 102 by utilizing an upload element 1102 shown in FIG. 11. The upload element 1102 may comprise a drag-and-drop functionality allowing a user to drag-and-drop a file directly to the upload element 1102. As shown, the upload element 1102 may also include an upload files button which, when selected, allows a user to navigate to a file location in order to upload a blueprint dataset. In some embodiments, a user may instead create a new project without uploading a blueprint dataset. For example, a project may be created from a blank template and the blueprint dataset may be uploaded at a later time.

Turning back to FIG. 4, as shown by operation 406, the apparatus 200 includes means, such as processing circuitry 202, memory 204, communications hardware 206, and/or the like, for receiving a blueprint dataset. As noted above, the blueprint dataset may be received via an upload element of the builder project management UI (e.g., from a user device, such as a client device 112A). In some embodiments, however, a blueprint dataset may be received by the builder project management system 102 via an out-of-band channel. For example, rather than uploading a blueprint dataset via upload element 1102, a builder may instead simply forward an email that includes the blueprint dataset (e.g., as an attachment to the email) to an email inbox associated with the builder project management system 102. The email inbox may be configured with listener functionality and automatically retrieve any received blueprint datasets and upload them to the builder project management system 102 accordingly. For instance, the builder project management system 102 may be configured to match a user email address used to login to an account associated with the builder project management system 102 to an email address from which a blueprint dataset is received in the email inbox. Once matched, a new project based on the blueprint dataset may be automatically generated for the particular user's account.

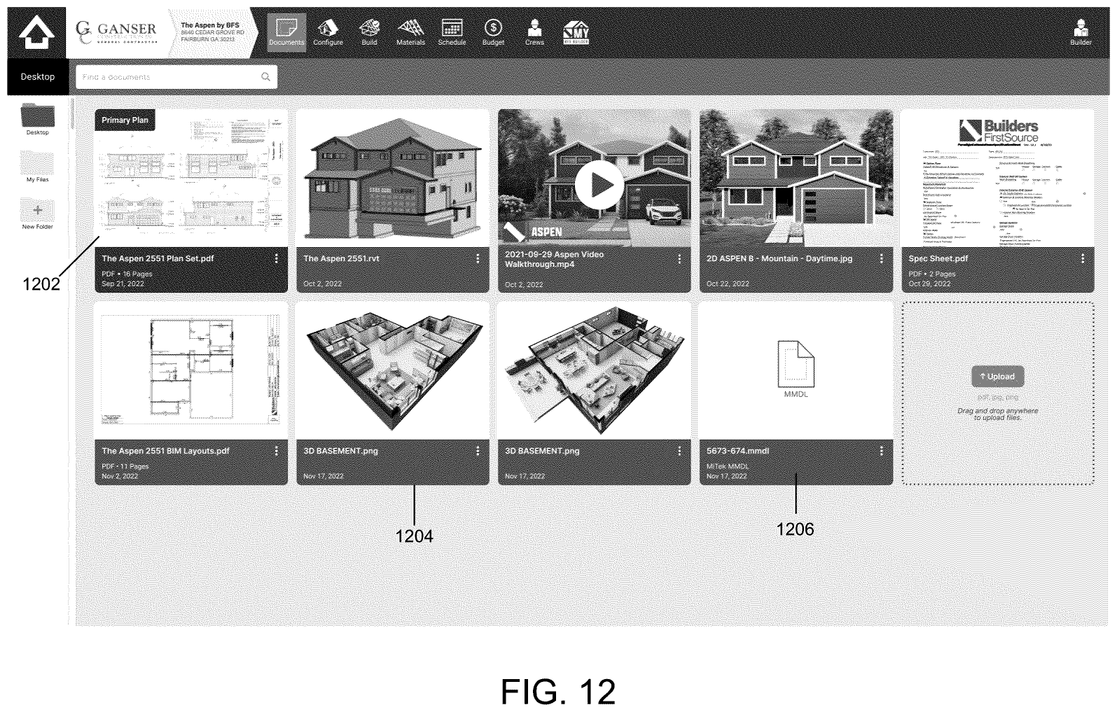

Once a blueprint dataset is uploaded (e.g., via upload element 1102), another view of the builder project management UI may be displayed, illustrated for example as builder project management UI 1200 shown in FIG. 12. As shown, a visual representation 1202 of the blueprint dataset may be displayed. In addition to a blueprint dataset, a user may optionally upload one or more additional files related to the project (e.g., for reference purposes). As shown in FIG. 12, an example user has uploaded two files in addition to a blueprint dataset, shown by visual representation 1204 and visual representation 1206. In some embodiments, the blueprint dataset may be visually indicated as a primary plan and differentiated from other uploaded files (e.g., by color). Each visual representation of the uploaded files may be selectable in that, once selected, information associated with the file may be displayed. In some embodiments, as shown in FIG. 12, each visual representation of an uploaded file may comprise an ellipses button (e.g., visually represented as three vertical dots) or another similar type of button that the user may select to rename or delete the uploaded file and also mark a file as a primary plan. The primary plan may be used by the builder project management system 102 in connection with various downstream processes, such as in generating digitized feature datasets (further described below).

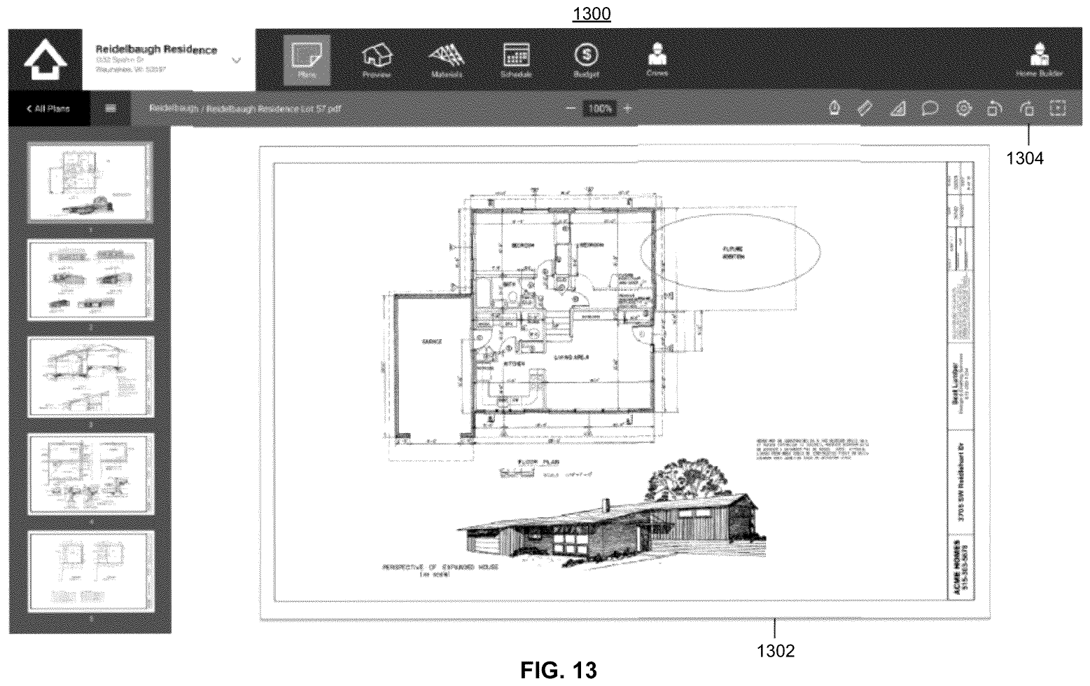

Upon selecting one of the visual representations of the uploaded files as shown in FIG. 12, another view of the builder project management UI may be displayed, illustrated for example as builder project management UI 1300 shown in FIG. 13. As shown, the builder project management UI 1300 includes an integrated plan viewer which displays pages of a blueprint dataset (or, for example, another uploaded file). In this regard, a first page 1302 of a blueprint dataset is displayed, and the side bar now includes additional pages of blueprint dataset which may also be selected for viewing and editing by the user. In addition, a toolbar 1304 is provided that enables a user to mark-up the displayed page of the uploaded file. Advantageously, the builder project management system 102 will automatically save any markup performed on an uploaded file as well as a clean version (without markup) allowing the user and/or other collaborators to maintain a copy of the original file.

In some embodiments, an uploaded blueprint dataset may optionally be pre-processed by the builder project management system 102. Returning to FIG. 4, as shown by optional operation 408, in some embodiments, the apparatus 200 includes means, such as processor 202, memory 204, input analysis circuitry 210, and/or the like, for pre-processing the blueprint dataset. In some embodiments, the blueprint dataset may be pre-processed in order to prepare the blueprint dataset for further analysis (e.g., by one or more models).

In some embodiments, pre-processing the blueprint dataset may involve a conversion of the blueprint dataset to a different file format. In this regard, the apparatus 200 includes means, such as processor 202, memory 204, input analysis circuitry 210, and/or the like, for converting the blueprint dataset from a first file format to a second file format. In some embodiments, a blueprint dataset may be converted to a rasterized image file. For instance, various trained models implemented by the builder project management system 102 may be configured to process rasterized images, and thus, certain file types (e.g., PDF, spreadsheets, etc.) may be automatically converted to a rasterized image file. In some embodiments, pre-processing may not be necessary, such as when the uploaded blueprint dataset is already in a rasterized image format. Advantageously, by converting the uploaded blueprint dataset into a rasterized image, the rasterized image may then be leveraged for additional purposes by the builder project management system 102, such as for automatically generating and displaying thumbnail images of portions of the blueprint dataset via the builder project management UI and/or the like.

As shown by operation 410, the apparatus 200 includes means, such as processor 202, memory 204, classifier circuitry 212, and/or the like, for classifying portions of the blueprint dataset. To do so, a classifier model may be used. The classifier model may comprise a trained ML model configured to map input data to a specific category. The classifier model may be trained in a supervised or unsupervised manner. For example, an unsupervised training process may be based on only unlabeled datasets, which are classified according to pattern recognition or structures and anomalies in the data. A supervised and semi-supervised training process may be based on labeled training datasets, from which classification of data according to predetermined categories is learned.

Regardless of the method of training, the trained classifier model may be configured to classify portions of a blueprint dataset into certain categories. In some embodiments, the classifier model may classify portions of the blueprint dataset on a page-by-page basis. For example, one page of the blueprint dataset may be a roofing diagram, another page may be an elevation, another page may be a floorplan, another page may be an electrical diagram, and so on. The classifier model may analyze each page to classify the page as a particular category (e.g., a particular portion of a structure). In some embodiments, the classifier model may be configured to classify portions of pages into different categories. For example, one page of the blueprint dataset may contain multiple categories (e.g., both a floorplan and an elevation) which may be recognized by the classifier model and classified accordingly.

Once the portions of the blueprint dataset are classified as described above, each classified portion may be further processed in order to generate a digitized feature dataset for the respective classified portion. In this regard, a digitized feature dataset may comprise line and measurement information determined for a classified portion (from which necessary materials for building the structure or portion thereof may be determined as further discussed below). As shown by operation 412, the apparatus 200 includes means, such as processor 202, memory 204, modeling circuitry 214, and/or the like, for generating digitized feature datasets for the classified portions of the blueprint dataset based on processing of the classified portions of the blueprint dataset by the one or more models.

In some embodiments, a suite of specially trained models (e.g., artificial intelligence (AI) models and/or the like) may be employed to process classified portions of the blueprint dataset in order to generate a digitized feature dataset comprising line and measurement information for the classified portions. For example, one specially trained model may be a roofing model that is configured to process a roofing diagram to label features and estimate measurements for the various features within a roofing diagram. In this regard, a rasterized image of the roofing diagram classified by the classifier model may be provided to the roofing model in order to do so. As another example, another specially trained model may be a siding model configured to receive an elevation diagram and identify, label, and estimate measurements of regions where siding would be placed when building the structure. The collection of digitized feature datasets generated as a result of output from the suite of specially trained models may collectively form a complete digitized plan for a structure (e.g., a house).

Once a complete digitized plan is generated, several optional operations may take place prior to generating material pack datasets, such as the operations illustrated in the flowchart shown in FIG. 5.

In some embodiments, a review of the digitized feature datasets generated as a result of output from the suite of specially trained models may take place to determine the overall accuracy of the digitized feature datasets. The review may involve confirming whether line and measurement information and labeling contained in the digitized feature datasets are correct and, if not, generating one or more updated digitized feature datasets that include updated, new and/or corrected data. In some embodiments, the review may be a manual review performed by one or more humans (e.g., engineers and/or other personnel associated with the builder project management system 102 and/or the user of the builder project management system 102). In this regard, as shown by operation 502, the apparatus 200 includes means, such as processor 202, memory 204, communications hardware 206, and/or the like, for receiving, prior to generating the one or more material pack datasets, one or more updated digitized feature datasets. For example, one or more updated digitized feature datasets may be received as input to the communications hardware in response to a manual review of one or more digitized feature datasets.

In some embodiments, any updated digitized feature datasets received by the builder project management system 102 may be leveraged as tools for re-training models originally used to generate the original digitized feature datasets. For instance, by providing the updated digitized feature datasets to their original models as training data, the models may continuously learn using the new, corrected, and/or updated data contained in the updated digitized feature datasets and be enabled to more accurately generate digitized feature datasets in the future. In this regard, as shown by operation 504, the apparatus 200 includes means, such as processor 202, memory 204, modeling circuitry 214, and/or the like, for causing re-training of at least one of the one or more models based on the updated digitized feature datasets. In some embodiments, the digitized feature datasets as well as any updated digitized feature datasets may be used to generate material pack datasets (discussed further below).

In some embodiments, the builder project management system 102, by way of the builder project management UI, may provide an option for generating a three-dimensional (3D) model of a structure defined in a blueprint dataset (and further refined in one or more digitized feature datasets generated by the builder project management system 102 as described above). In this regard, as shown by operation 506, the apparatus 200 includes means, such as processor 202, memory 204, three-dimensional modeling circuitry 218, and/or the like, for generating a 3D model of a structure based on digitized feature datasets. As noted earlier, the three-dimensional modeling circuitry 218 may employ one or more algorithms that are configured to generate a 3D model from 2D line and measurement information.

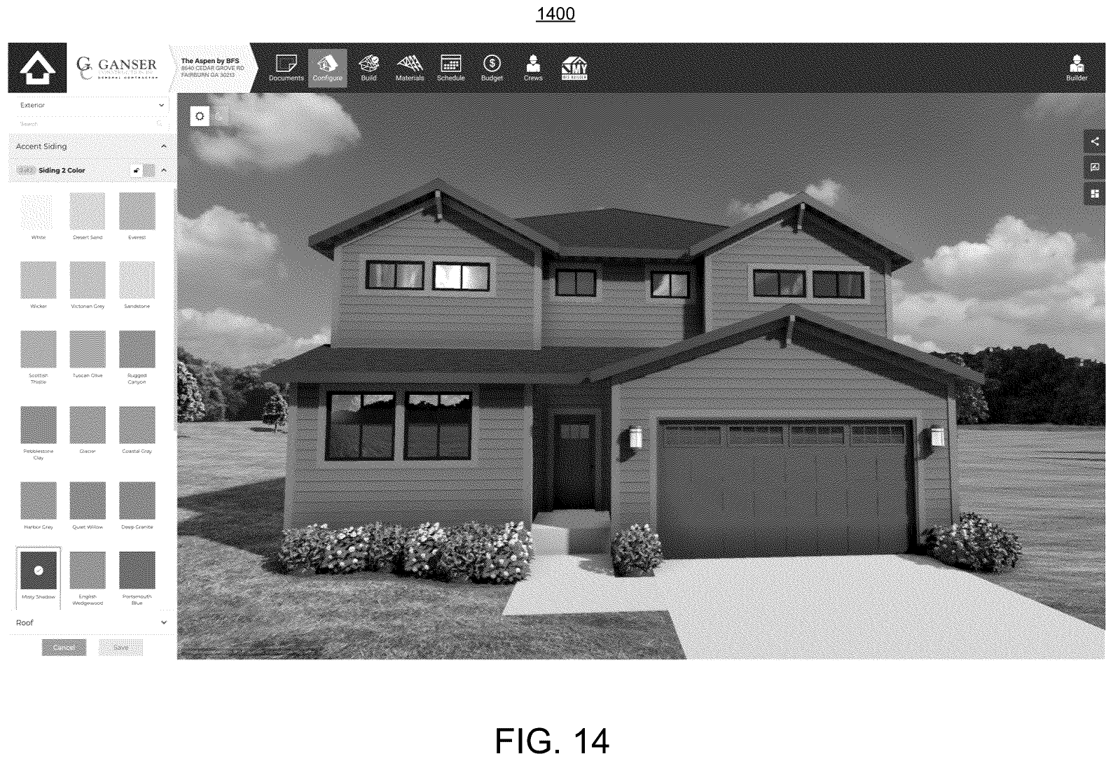

As shown by operation 508, the apparatus 200 includes means, such as processor 202, memory 204, communications hardware 206, and/or the like, for causing presentation of the 3D model of the structure via the builder project management UI. Turning briefly to FIG. 14, an example builder project management UI 1400 is shown that provides a view of a 3D model generated based on digitized feature datasets. In some embodiments, the 3D model is incorporated in an interactive and configurable visualization that includes various controls which can be selected by the user in order to perform various operations with the 3D model. For example, the visualization may allow for a full 360-degree view of the exterior and/or interior of a structure with a plurality of viewpoints. In some embodiments, various sections of the structure may be selectable allowing more information regarding a specific section to be displayed when selected. The visualization may also comprise controls for viewing the 3D model in a daytime setting as well as a nighttime setting. In some embodiments, the 3D model may be exportable, for example, allowing a builder to share the 3D model with a buyer or potential buyer of the home. As shown in FIG. 14, the side bar may include various menus directed to various features of the structure, which may be selected to view more information and/or change viewing options for the various features within the 3D visualization. For example, the user may select different options from the “Front Door” menu in order to visualize what the home would look like with various styles of front doors.

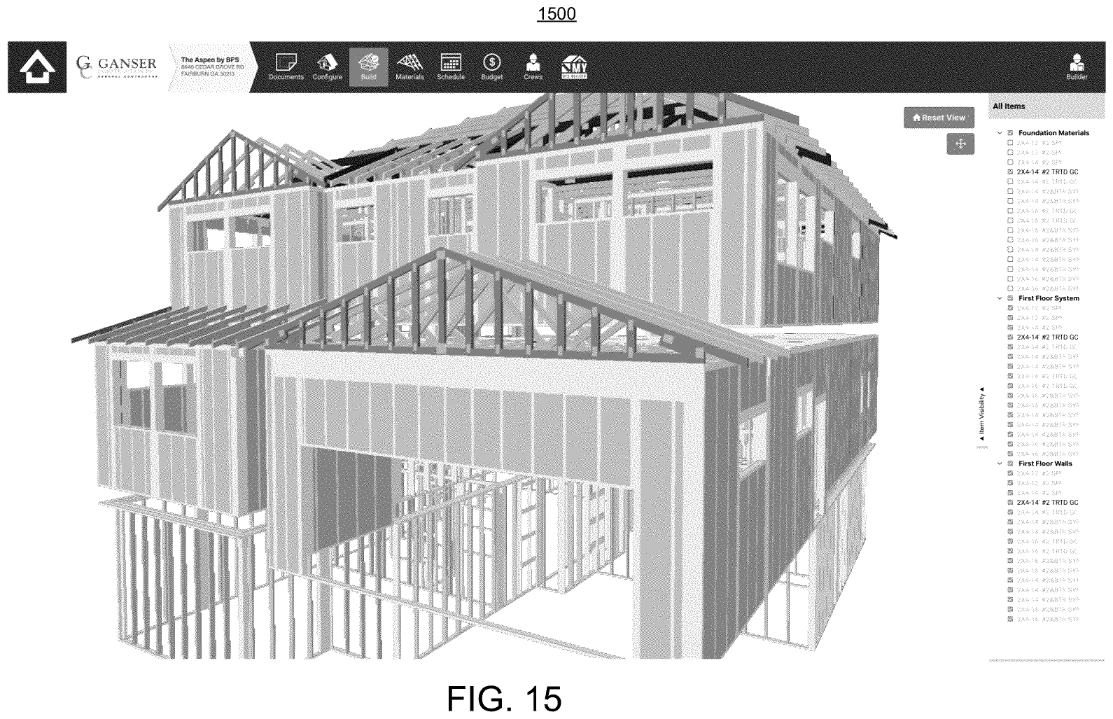

In some embodiments, in connection to a 3D model of an exterior (and/or interior) of a structure, a 3D framing model may also be generated which provides a view of the framing of the structure. FIG. 15 shows an example builder project management UI 1500 that provides a view of a 3D framing model generated based on digitized feature datasets. Like the 3D model shown in FIG. 14, the 3D framing model is also incorporated in an interactive and configurable visualization that includes various controls which can be selected by the user in order to perform various operations with the 3D framing model. As shown in FIG. 15, the side bar may include various options directed to various features of the framing of the structure, which may be selected to view (or not view) the various features within the 3D visualization. For example, as shown in FIG. 15, all options are selected with the exception of the “Roof Frame” option; thus, the roof frame is not actively being shown in the visualization of the 3D framing model.

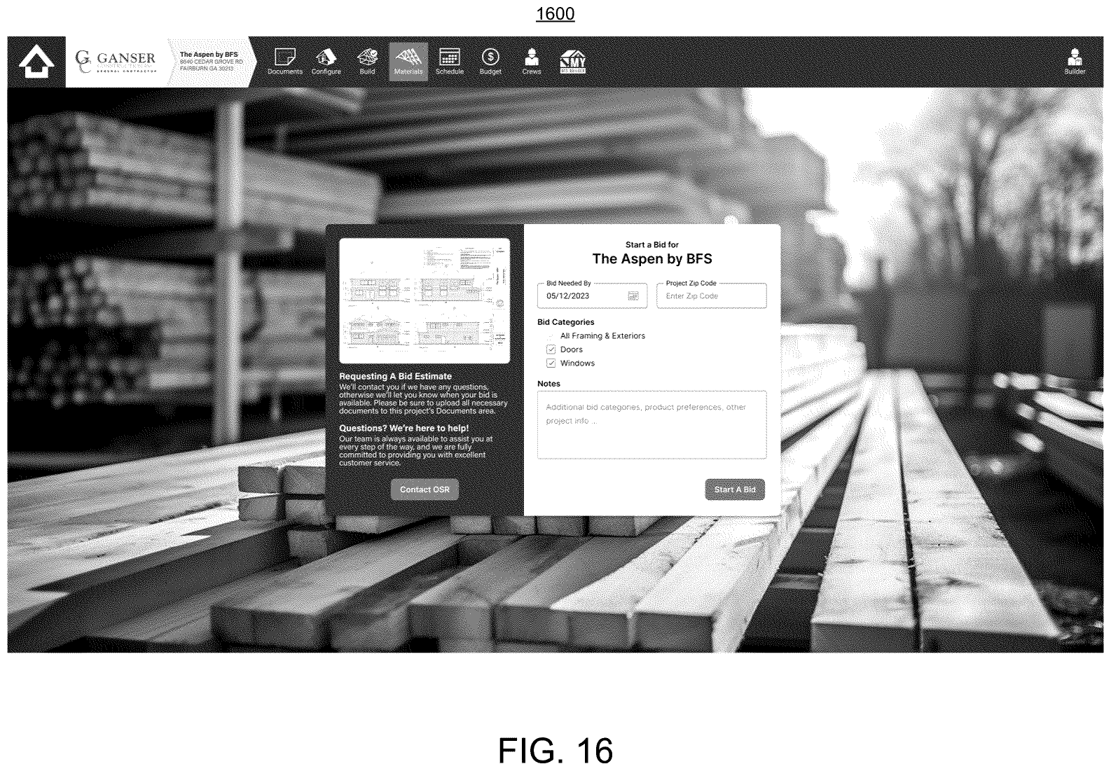

In some embodiments, once a digitized plan is generated for an uploaded blueprint dataset, a user may generate a bid request via the builder project management UI. Turning briefly to FIG. 16, an example builder project management UI 1600 is shown that provides a view enabling a user to generate a bid request (e.g., by selecting the request bid estimate button 1602). The bid request may trigger generation of one or more material pack datasets by the builder project management system 102 and, in some embodiments, communications with one or more remote data sources (e.g., remote data sources 110A-110N) such as various supplier systems, databases, and/or the like to obtain pricing information for various materials, further discussed below.

In this regard, turning back to FIG. 4, as shown by operation 414, the apparatus 200 includes means, such as processor 202, memory 204, material calculation engine 216, and/or the like, for generating, based on the digitized feature datasets, one or more material pack datasets. In some embodiments, a material pack dataset may comprise data representing materials needed for building a portion of a structure associated with a digitized plan (e.g., the collective digitized feature datasets).

The material calculation engine 216 may generate material pack datasets based on the line and measurement information of the digitized feature datasets as well as additional parameters. In this regard, the material calculation engine 216 may be configured to apply various formulas having parameters to the line and measurement information in order to determine a complete listing of materials required for building a structure. In some embodiments, the parameters may include various user preferences that may be pre-configured by the user of the builder project management system 102. For example, the user may specify certain preferences in their user profile associated with the builder project management system 102 and these preferences may be stored (e.g., in storage device 106) and referenced by the material calculation engine 216 when generating material pack datasets. The user preferences may include a wide variety of preferences. For example, the user preferences may indicate certain styles of fixtures, types of wood, certain suppliers, and/or the like that the builder prefers to use when building a structure. Additionally, the parameters may include specific building practice and code information based on a location in which the structure is to be built. For example, due to local or regional codes, certain materials may not be used to build structures (e.g., due to factors such as climate or the like). Advantageously, the material calculation engine 216 may take these factors into account when materials to be included in material pack datasets.

Turning to FIG. 6, a flowchart including various operations performed by the material calculation engine 216 is shown. In some embodiments, the material calculation engine 216 may utilize one or more optimized subroutines to determine materials for certain sections of a structure. In this regard, as shown by operation 602, the apparatus 200 includes means, such as processor 202, memory 204, material calculation engine 216, and/or the like, for determining, using one or more optimized subroutines, an optimal amount of material needed for a respective portion of the structure based on the line and measurement data. For instance, one example optimized subroutine may be executed to calculate amounts of materials needed for headers (beams over openings that disperse the structural load to the outside of the openings to keep structural integrity) in a house. A less optimized approach may simply count the number of doors in the structure and sum the lengths of the doors, and output an indication that, e.g., 120 feet of 2×12 lumber is needed for all of the headers. However, this information does not help a builder to order the materials, as some headers may be different lengths than others. Advantageously, the material calculation engine 216 may use an optimized subroutine to determine and output specific lengths of lumber as well as how (e.g., at what length) the lumber should be cut for various headers in the structure. It is to be appreciated that other optimized subroutines may be applied to various features or sections of the structure (other than headers), such as roof rafters and/or the like.

In addition to determining materials needed, pricing information and purchasing options for the materials may also be determined by the builder project management system 102. For instance, in various embodiments, suppliers may be enabled to “bid” on material packs via the builder project management system 102, or, in other words, provide a quote to the user based on the supplier's respective pricing of the materials. In some embodiments, material pack datasets may be organized by supplier. For example, a user may be presented with two different material pack datasets (e.g., containing substantially the same materials while having different SKUs), each priced differently and associated with different suppliers.

In order to generate material pack datasets, the material calculation engine 216 may first assign a base SKU to each material determined to be needed for building the structure. For instance, the base SKU may be a general SKU maintained by the builder project management system 102 that can be mapped to actual real-world SKUs used by various suppliers. In some embodiments, the builder project management system 102 may store a mapping of base SKUs to actual supplier SKUs which may be routinely updated as SKUs are introduced or updated by suppliers. In this regard, as shown by operation 604, the apparatus 200 includes means, such as processor 202, memory 204, material calculation engine 216, and/or the like, for assigning, for a respective digitized feature set, a base stock keeping unit (SKU) to each material needed for building a portion of the structure.

In some embodiments, a base SKU may then be mapped to one or more supplier SKUs in order to then gather pricing information for the SKU. However, the builder project management system 102 may take additional information into account when mapping SKUs. For example, user preferences may be factored in to determine which SKUs to include in material pack datasets. In this regard, as shown by operation 606, the apparatus 200 includes means, such as processor 202, memory 204, material calculation engine 216, and/or the like, for mapping a base SKU to one or more supplier SKUs based on a user preference set. For example, as noted above, users may specify certain preferences in their user profile associated with the builder project management system 102 and these preferences may be stored (e.g., in storage device 106) and referenced by the material calculation engine 216. For example, in some embodiments, user preferences may indicate one or more suppliers that the user prefers to work with and purchase materials from, and additionally may indicate one or more suppliers that the user does not prefer to purchase materials from. As another example, in some embodiments, user preferences may indicate a specific manner in which a user would like material pack datasets to be organized.

Once various supplier SKUs are determined for the materials indicated in material pack datasets, pricing information may be applied to the material pack datasets. In this regard, as shown by operation 608, the apparatus 200 includes means, such as processor 202, memory 204, supplier bid circuitry 220, and/or the like, for applying pricing information to the one or more material pack datasets based on supplier inventory data. For instance, a price summing all materials of a material pack dataset may be indicated to the user via the builder project management UI. In some embodiments, pricing information may be gathered based on data stored by the builder project management system 102. For example, supplier inventory data and associated pricing can be automatically scraped and cataloged from supplier websites by the builder project management system 102 (e.g., using one or more web scraper tools). In some embodiments, pricing information (e.g., in the form of a bid) can be provided directly from the supplier to the builder project management system 102 after the supplier receives and processes a material pack dataset. The pricing information can be specific to one or more of the customer, location and time of order.

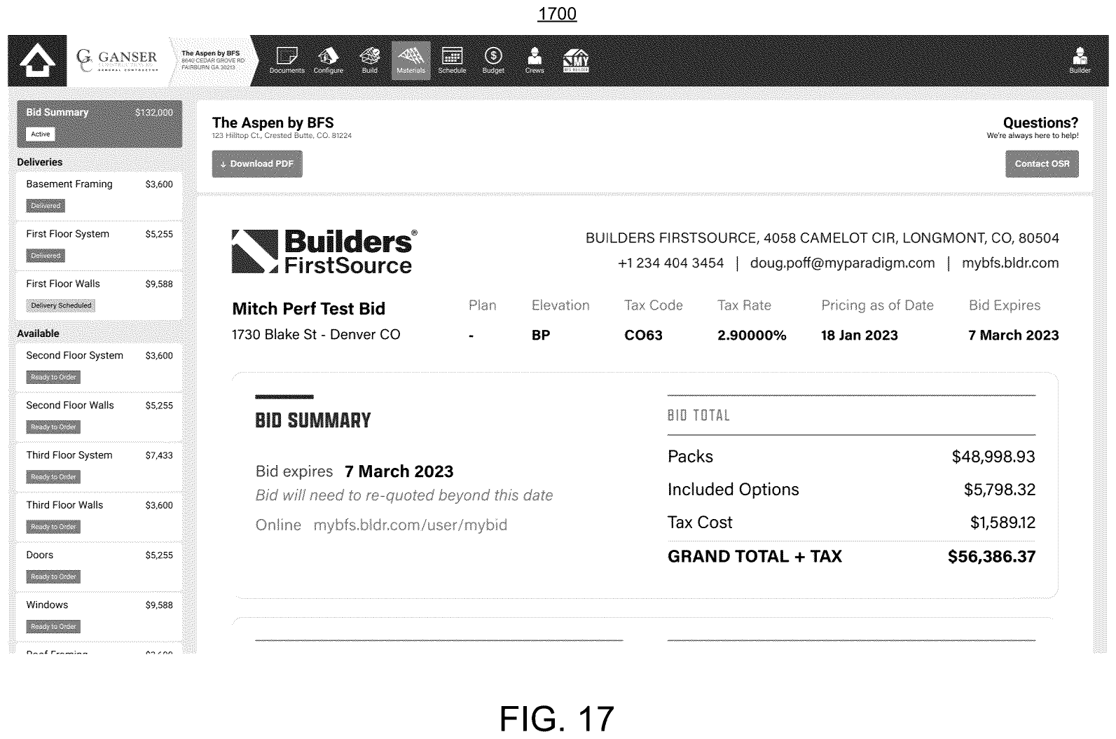

Returning to FIG. 4, as shown by operation 416, the apparatus 200 includes means, such as processor 202, memory 204, communications hardware 206, and/or the like, for causing presentation of a visual representation of the one or more material pack datasets via the builder project management UI. To illustrate, FIG. 17 shows an example builder project management UI 1700 that provides a view containing information regarding multiple material pack datasets.

As shown in FIG. 17, the example builder project management UI 1700 includes a side bar that contains a listing of example material pack datasets generated by the material calculation engine 216 of the builder project management system 102. As shown, each material pack dataset in the listing of the sidebar may indicate an order status. In the example shown in FIG. 17, each material pack dataset includes an order status of “Ready to Order,” indicating that none of the material pack datasets have yet been ordered. Additionally, each material pack dataset in the listing of the sidebar may indicate pricing information. The pricing information may indicate a total sum of all prices of materials included in the material pack dataset.

In some embodiments, each material pack dataset indicated in the listing of the sidebar may be selectable, and, when selected, the builder project management system 102 may cause display of additional information regarding the selected material pack dataset. For example, the example material pack datasets include a “First Floor System” material pack dataset which is presently selected (as indicated by the darker color compared to other material pack datasets in the listing) and, due to being selected, information regarding the “First Floor System” material pack dataset is presently displayed in the example builder project management UI 1700.

In some embodiments, the information displayed regarding the selected material pack dataset may include visual representations of the various materials needed for building the portion of the structure associated with the material pack dataset (e.g., the first floor of a home as shown for example in FIG. 17). As shown in the example builder project management UI 1700, the visual representations may include names and measurement information for the various materials, brief descriptions of the materials, a quantity for each material, pricing information by the each, and pricing information for the quantity of the specific material. As shown, a stock image of the materials may also be displayed in connection with the visual representations. Through the builder project management UI, a user may browse through each material pack dataset (e.g., via the listing of the sidebar) and gain powerful insights into the construction of a house (or other structure), including the ability to view every material needed to build the house, measurement information, and pricing information all in one digital space.

In some embodiments, the builder project management UI may also enable a user to place an order of one or more material pack datasets. To do so, the user may select an order button 1702 displayed in connection with each material pack dataset. For example, by selecting order button 1702 as shown in FIG. 17, the user may be directed to various interfaces for providing information to purchase and order the materials of the “First Floor” material pack dataset.

FIG. 7 shows a flowchart illustrating example operations for ordering and scheduling via a builder project management UI. In some embodiments, when a user places an order of a material pack dataset (e.g., by interacting with order button 1702), a user order indication may be received by the builder project management system 102 in order to process the order. The user order indication may comprise a data construct indicating various details about the order, such as the particular user who placed the order, the material pack dataset ordered, requested delivery information (e.g., a requested delivery date), address information, payment information, and/or the like. In this regard, as shown by operation 702, the apparatus 200 includes means, such as processor 202, memory 204, communications hardware 206, and/or the like, for receiving a user order indication of at least one material pack dataset via the builder project management UI.

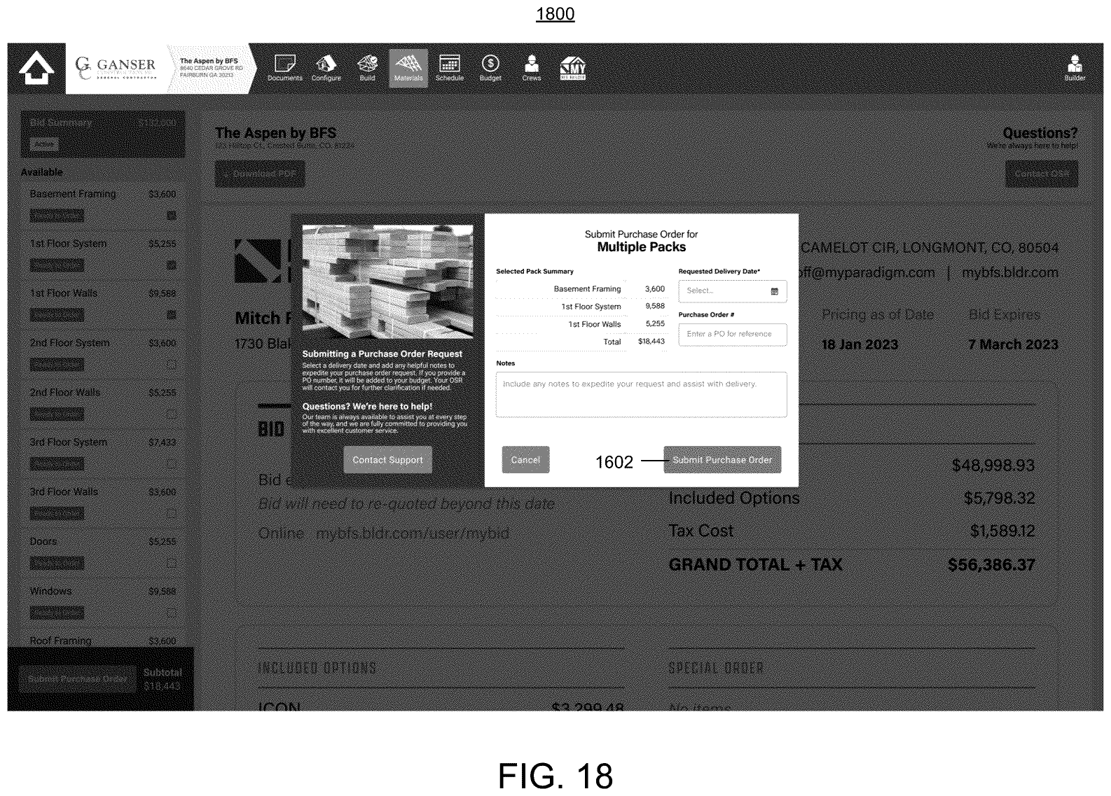

Turning briefly to FIG. 18, an example builder project management UI 1800 is shown that may be displayed during an order process of a material pack dataset (e.g., after the user has selected order button 1702). As shown, the user may specify a requested delivery date for the material pack dataset (and for each material pack dataset ordered via the builder project management system 102). Additionally, the user may provide delivery instructions and/or other instructions associated with the material pack dataset. In this regard, the apparatus 200 includes means, such as processor 202, memory 204, scheduling engine 224, and/or the like, for scheduling a delivery of the order of materials based at least on the requested delivery date.

Upon selecting the submit order button 1802, the builder project management system 102 may receive the user order indication and cause execution of an order of materials associated with the material pack dataset. In this regard, as shown by operation 704 in FIG. 7, the apparatus 200 includes means, such as processor 202, memory 204, ordering circuitry 222, and/or the like, for executing an order of materials associated with at least one material pack dataset. In some embodiments, the builder project management system 102 may connect and communicate with supplier systems that supply the various materials of the material pack datasets (e.g., any of remote data sources 110A-110N) to allow a user to purchase and order the materials by way of the builder project management UI. In some embodiments, however, the builder project management system 102 may be managed by or otherwise associated with a supplier of the materials, such that purchasing and ordering of the materials may be performed within the builder project management system 102 without the need to communicate with external supplier systems.

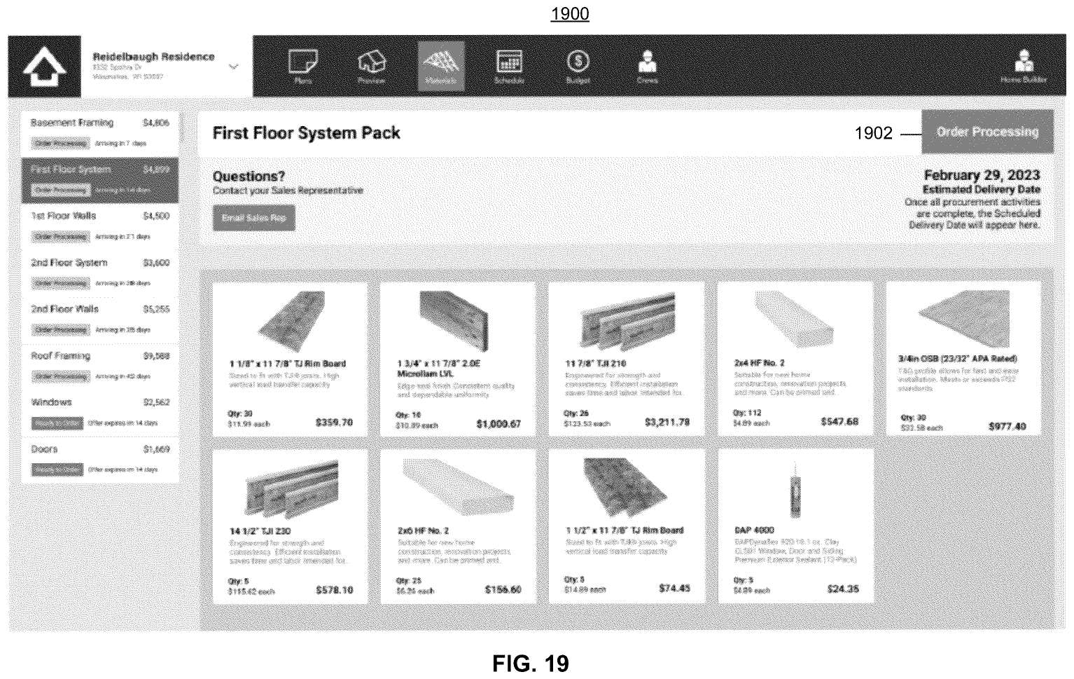

As shown by operation 706, the apparatus 200 includes means, such as processor 202, memory 204, communications hardware 206, and/or the like, for causing presentation of a visual representation of an order status for at least one material pack dataset. To illustrate, FIGS. 19-21 provide example views of various builder project management UIs at various stages of orders.

As shown in FIG. 19, an example builder project management UI 1900 is shown that provides an indication 1902 of the order status of materials for the “First Floor System” material pack dataset. As shown, the order status is indicated as “Order Processing,” which may indicate that the order has not yet been delivered and/or not yet out for delivery. Additionally, the project management system 102 may generate an estimated delivery date for the material pack dataset and cause presentation of the estimated delivery date via the builder project management UI, as shown in FIG. 19.

In some embodiments, the builder project management UI may provide a consolidated view of all material pack datasets and their associated order statuses. In this regard, the apparatus 200 includes means, such as processor 202, memory 204, communications hardware 206, and/or the like, for simultaneously displaying order statuses of one or more material pack datasets within the builder project management UI. As shown for example in FIG. 19, the side bar includes order statuses for each of the material pack datasets listed. As shown, two material pack datasets (“Windows” and “Doors”) have not yet been ordered and include an order status of “Ready to Order,” whereas the remaining material pack datasets listed include an order status of “Order Processing,” indicating that they have been ordered. By synthesizing order status information with material information in a consolidated view, a builder (or other user) interacting with the builder project management system 102 is able to more quickly assess the current scope of a project and more readily identify key points that may still need to be addressed when compared with conventional project management approaches.

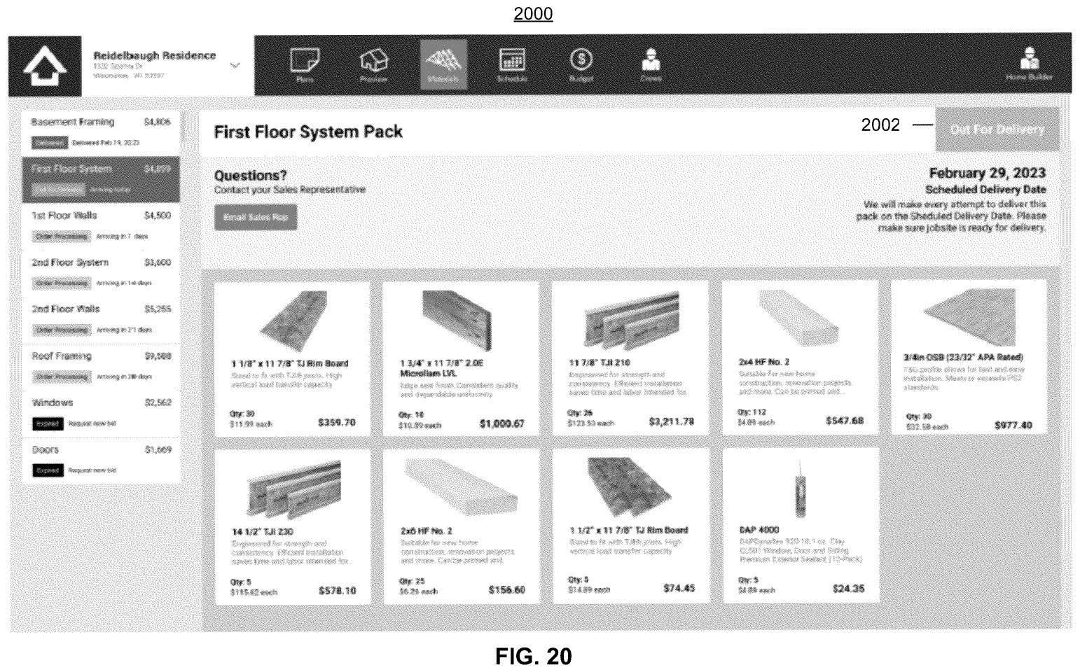

In some embodiments, the builder project management system 102 may automatically update order statuses and cause presentation of updated order statuses as orders progress. For example, as shown in FIG. 20, an example builder project management UI 2000 shows an indication 1802 of the order status of materials for the “First Floor System” material pack dataset, which is now indicated as “Out For Delivery.” Additionally, the project management system 102 may update the estimated delivery date for the material pack dataset to a scheduled delivery date and cause presentation of the scheduled delivery date via the builder project management UI, as shown in FIG. 20. In some embodiments, order statuses may be updated based on collating order information from supplier systems (e.g., any of remote data sources 110A-110N) based on an order number and/or other order information.

In some embodiments, certain pricing information for one or more material pack datasets may be time sensitive. For example, a bid or price offer from a supplier for a particular material pack dataset may expire after not having ordered the material pack dataset at that price within a certain time period. Upon expiration, the order status may be updated to “Expired” as shown for example on the “Windows” and “Doors” material pack datasets listed in the side bar in FIG. 20. The user may request a new bid for any material pack datasets that happen to expire via the builder project management UI. By doing so, the material pack datasets may again be updated with new pricing information (e.g., for another period of time).

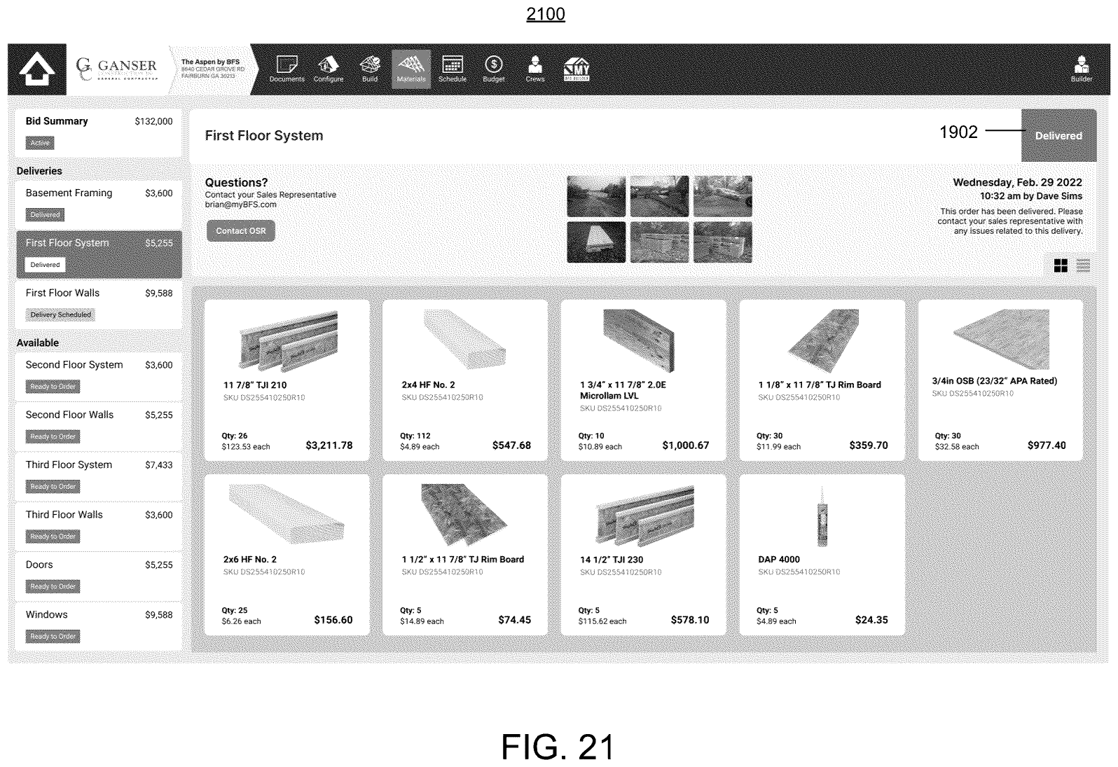

As shown in FIG. 21, an example builder project management UI 2100 shows an indication 2102 of the order status of materials for the “First Floor System” material pack dataset, which is now indicated as “Delivered.” Additionally, the project management system 102 may update the scheduled delivery date for the material pack dataset to an actual delivery date (as well as an actual delivery time) and cause presentation of the actual delivery date via the builder project management UI, as shown in FIG. 21. In some embodiments, delivery photos may also be displayed via the builder project management UI 2100 (e.g., based on collated information from supplier systems) as shown in FIG. 21.

In some embodiments, the builder project management system 102 may provide scheduling tools that generate a recommended delivery schedule for various materials (e.g., material pack datasets). In addition to a recommended delivery schedule, a user may be enabled to manually create and adjust schedules within the builder project management UI. In order to generate a recommended delivery schedule, the builder project management system 102 may leverage several sources of data to determine an optimal schedule based on both builder and supplier needs. In this regard, as shown by operation 708 of FIG. 7, the apparatus 200 includes means, such as processor 202, memory 204, scheduling engine 224, and/or the like, for generating a recommended delivery schedule for materials associated with one or more material pack datasets. In some embodiments, the recommended delivery schedule may be generated based on the received blueprint dataset and, in some embodiments, also on builder profile information associated with the received blueprint dataset.

In some embodiments, builder profile information may, in addition to various user preferences, include data associated with a transactional order history. For example, orders, requested deliveries, and other related information generated by a user while using the builder project management system 102 over time may be stored and leveraged to determine optimal scheduling for material deliveries. As one example, the builder project management system 102 may learn estimated construction timing for various types of projects based on a user's ordering and delivery history. For instance, for projects involving blueprint datasets of houses less than 3000 square feet, the builder may typically schedule or otherwise tolerate a delivery of first floor materials and second floor materials two weeks apart. The builder project management system 102 may harness this information to learn that it likely takes the builder two weeks to complete construction of a first floor system and take this factor into account when determining a recommended delivery schedule for a new project created by the user that involves a house that is less than 3000 square feet.

In addition to builder profile information (e.g., transactional order history) and blueprint datasets, other information may also be utilized by the builder project management system 102 to generate an optimal recommended delivery schedule for a project. For example, the scheduling engine 224 may also factor in additional parameters.

In some embodiments, the parameters may include forecasted weather data. In this regard, the scheduling engine 224 may retrieve third-party weather data (e.g., from various weather data sources) for location(s) associated with the structure to be constructed from the blueprint dataset. As one example, the scheduling engine 224 may postpone or advance a delivery of one or more material packs based on an upcoming thunderstorm expected to last two days. This adjustment may also cause the scheduling engine 224 to adjust other delivery dates for one or more additional material packs.

For example, in order to postpone or advance a delivery, the builder project management system 102 may generate and cause communication of a delivery adjustment notification to one or more remote supplier systems associated with the materials to be delivered. The delivery adjustment notification may include data regarding orders of one or more material pack datasets (e.g., an order number and/or other identifying information) and may also include an indication of an updated delivery date (e.g., as determined by the scheduling engine 224). Advantageously, the builder project management system 102 may enable two-way communication such that a remote supplier system may communicate (e.g., over communications network 108) with the builder project management system 102 in response to a delivery adjustment notification. For instance, a supplier system may provide a responsive notification to the delivery adjustment notification which may include various information, such as an acceptance of the updated delivery date or the like. In some embodiments, adjusting a delivery date may cause issues on the supplier side (e.g., the supplier may only deliver certain days, may have already shipped the order, etc.) which the supplier can indicate in the responsive notification. In some embodiments, the scheduling engine 224 may process the response notification to further adjust any scheduling information needed based on the information provided in the responsive notification.

In some embodiments, the parameters may include regional building practice and code information. In this regard, the scheduling engine 224 may retrieve regional building and code information (e.g., from third-party sources or pre-stored information) associated with a region in which the structure is to be constructed and use the information to determine whether local laws and/or codes may impact construction timing (e.g., inspections may be required at certain points of construction) and adjust the recommended delivery schedule accordingly (e.g., by causing transmission of a delivery adjustment notification to one or more supplier systems as discussed above).

In some embodiments, the parameters may include calendar event data. In this regard, the scheduling engine 224 may retrieve event data (e.g., from various sources such as digital calendars of suppliers, builders, or more general sources) which may be related to the location of the structure to be constructed. As one example, the scheduling engine 224 may postpone or advance a delivery of one or more material packs (e.g., by causing transmission of a delivery adjustment notification to one or more supplier systems as discussed above) based on an upcoming holiday (e.g., a day in which construction crews are unavailable) or other local events which may impact construction. This adjustment may also cause the scheduling engine 224 to adjust other delivery dates for one or more additional material packs.

In some embodiments, the parameters may include restriction data, such as supplier restriction data and/or builder restriction data. In this regard, the scheduling engine 224 may retrieve data (e.g., from suppliers and/or builders, their subcontractors, etc.) which may be relevant to the delivery of materials and/or the general construction of the structure. As one example, the scheduling engine 224 may postpone a delivery of one or more material packs based on a particular material being out-of-stock at the supplier. As another example, the scheduling engine 224 may postpone or advance a delivery (e.g., by causing transmission of a delivery adjustment notification to one or more supplier systems as discussed above) of one or more material packs based on restrictions of the builder, such as availability of crews to accept deliveries and/or other restrictions. This adjustment may also cause the scheduling engine 224 to adjust other delivery dates for one or more additional material packs.

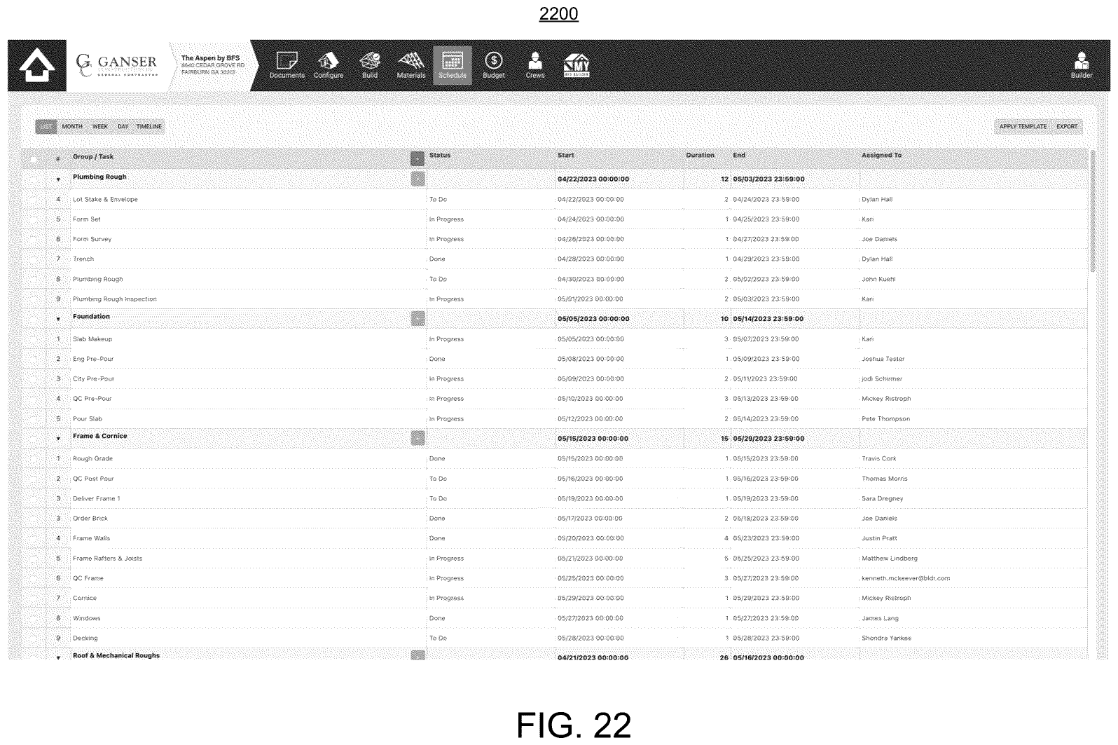

FIG. 22 shows an example builder project management UI 2200 which may be displayed in response to a user selecting the “Schedule” button on the navigation bar. As shown, scheduling tools are provided which allow for automated and manual entry of tasks that may be required to be completed by various crew members. As shown, for example, tasks may be scheduled and organized into groups of related tasks and displayed in a tabular format via the builder project management UI 2200. In some embodiments, each task may be associated with a status, a start date and/or end date, and an assignment to a particular crew member. In some embodiments, a user may add or remove groups of tasks, as well as add new columns relating to other information regarding the groups and/or tasks. In some embodiments, an export button 2202 may be included that exports the task schedule (e.g., in a preferred file format) from the builder project management system 102.

FIG. 22 shows an example builder project management UI 2200 which may be displayed in response to a user selecting the “Budget” button on the navigation bar. As shown, budgeting tools are provided by the builder project management system 102 which allow for automated and manual entry of invoices that may be managed and paid via the builder project management UI 2200. In this regard, a complete picture as to the cost of a project is presented in an easily digestible manner such that a builder is enabled to efficiently review outstanding balances and coordinate payments in a timely manner. In some embodiments, invoice data may be automatically added to the tabular listing (e.g., as shown in FIG. 22) in response to material pack datasets being ordered via the builder project management system 102.

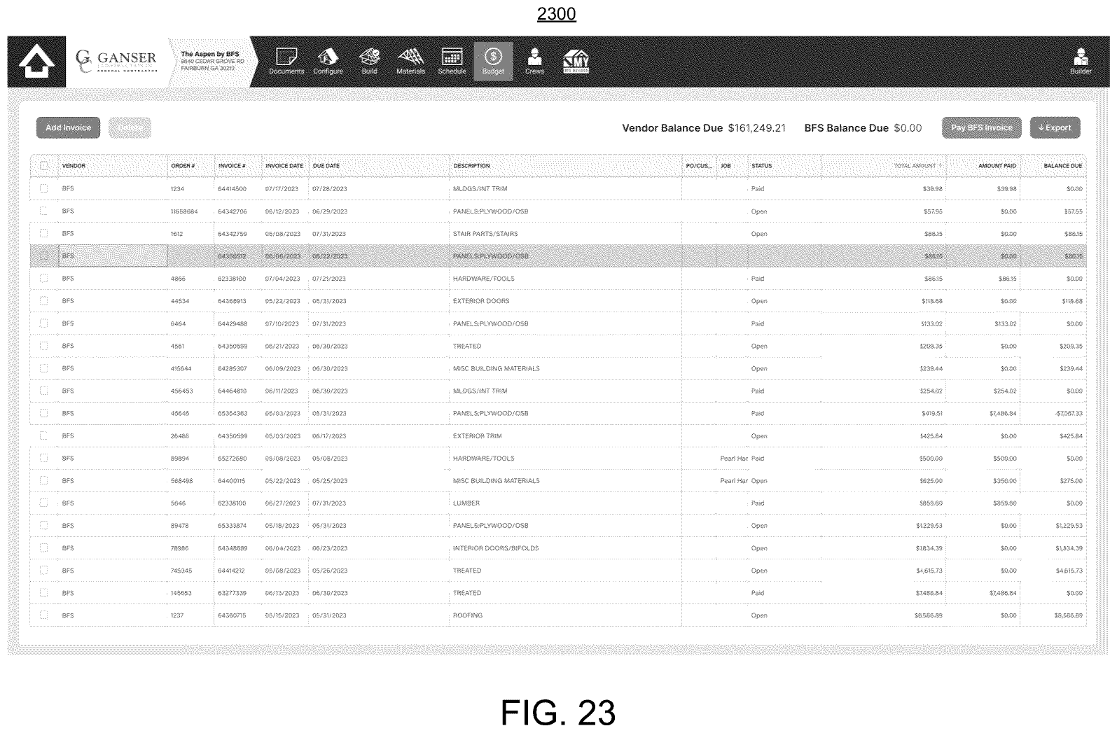

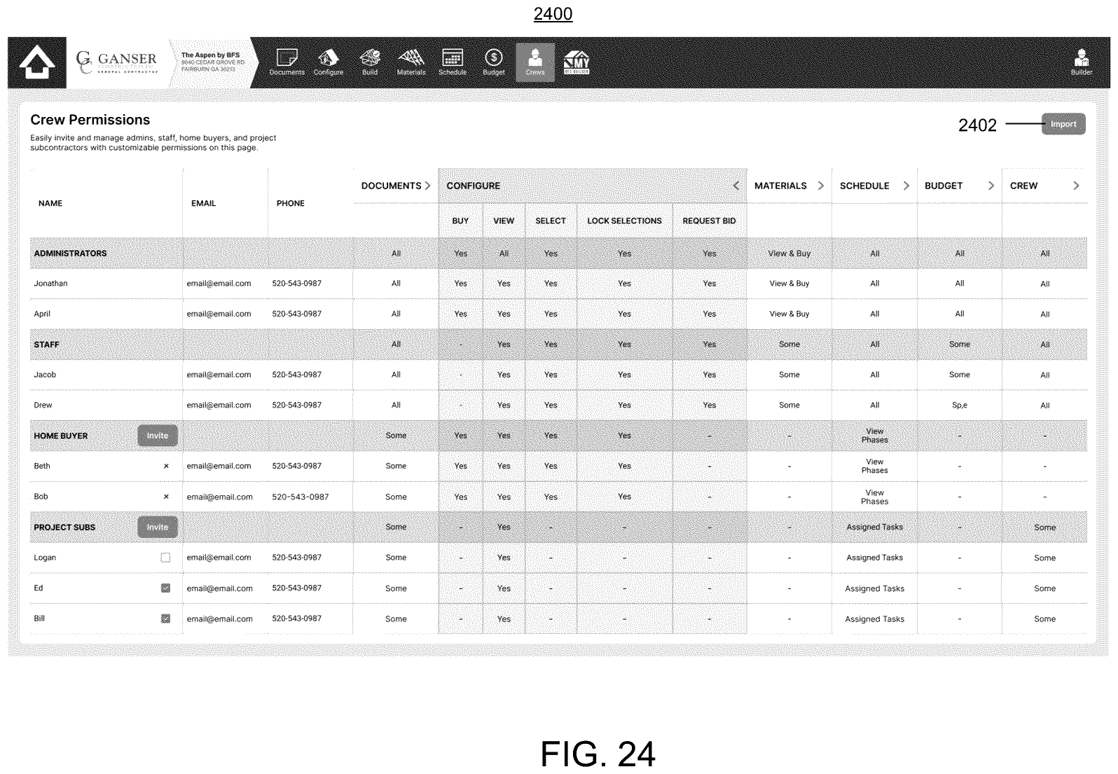

FIG. 24 shows an example builder project management UI 2400 which may be displayed in response to a user selecting the “Crews” button on the navigation bar. As shown, crew management tools are provided by the builder project management system 102 which allow for automated and manual entry of crew member data that may be managed via the builder project management UI 2400. In this regard, a complete picture of a project's crew members and supporting company administration members is presented in an easily digestible manner and enables a builder to efficiently communicate and coordinate with individuals important to a project's development. In some embodiments, invoice data may be automatically added to the tabular listing (e.g., as shown in FIG. 23) in response to material pack datasets being ordered via the builder project management system 102. In some embodiments, certain members listed may have access to various information about the project via the builder project management system 102. For example, some crew members with certain permissions may view material pack datasets, uploaded blueprint datasets, and/or the like via their own personal account associated with the builder project management system 102.

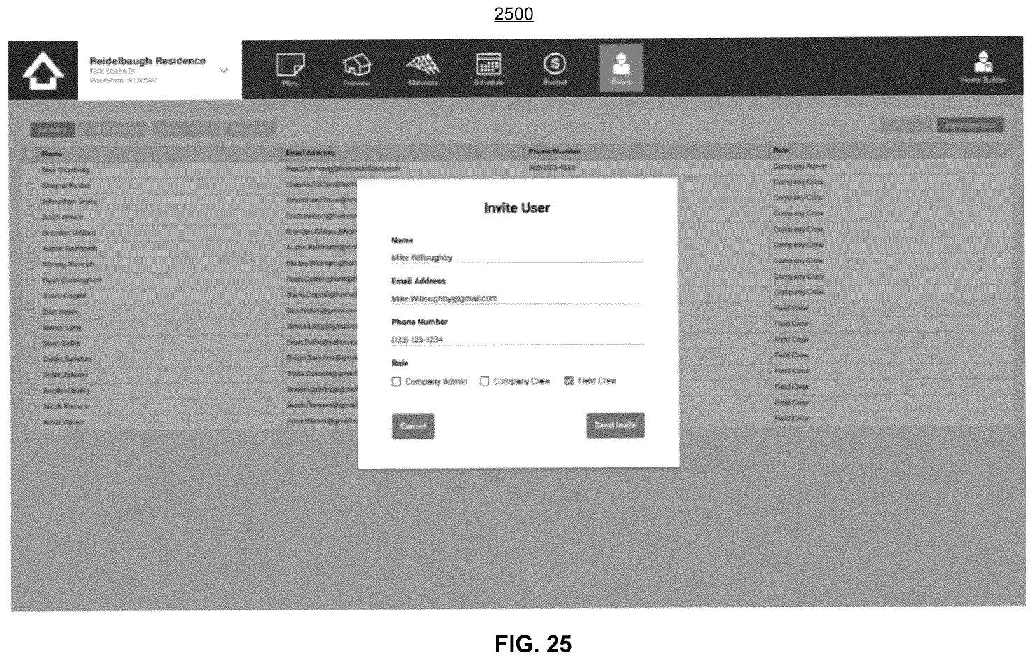

In some embodiments, a crew member may be added to the project by selecting the invite new user button 2402. When the invite new user button 2402 is selected, an additional view may be presented, shown for example in FIG. 25 as builder project management UI 2500. As shown, an overlaid dialog box may be displayed allowing a builder to input various information for a crew member to be added to the project, including name, contact (e.g., phone, email) information, and a selected role for the crew member. By selecting the send invite button 2502, the crew member may be invited (e.g., by email) to join the project and access various information about the project via the builder project management system 102.

In some embodiments, the builder project management system implements a hierarchical management sub-system of building materials and construction methods. In some embodiments, the hierarchical management sub-system is implemented with apparatus 200 of FIG. 2. In some other embodiments, the hierarchical management sub-system is implemented with apparatus with a separate apparatus from apparatus 200 or with portions of apparatus 200.

FIG. 8 is a data flow diagram of some embodiments of a hierarchical management sub-system. Referring to FIG. 8, a database 801 stores building materials and construction methods. Examples of construction methods include, but are not limited to, use of redi-frame, use of slab construction, use of traditional timber framing, use of under-slab foam insulation, use of treated lumber for sill plates, use of various floor systems such as, for example, dimensional lumber, i-joist, or open web trusses, etc. The building materials and construction methods can be obtained from one or more suppliers and one or more builders (e.g., homebuilders, etc.). For example, the building materials can include all the types of materials that may be included in the construction of a house. In some embodiments, these building materials and construction methods are provided to database 801 via an interface (e.g., an interface generated by interface generation circuitry 208, etc.) and communications hardware (e.g., communications hardware 206, etc.). In some embodiments, these building materials and construction methods can be those used across the country. In some other embodiments, these building materials and construction methods can be those used in one or more countries. Database 801 can be located remotely and accessed over one or more communication networks.

In some embodiments, the hierarchical management sub-system includes a supplier curation engine 802 communicably coupled to access and receive data from database 801. In some embodiments, the supplier curation engine 802 comprises software instructions (e.g., application software and/or system software, such as firmware) stored on a memory (e.g., memory 204) accessible to one or more processors (e.g., processor 202). These software instructions, when executed by a processor, allow the supplier curation engine 802 to curate which building materials from database 801 are available from one or more suppliers and which construction methods are commonly used to generate that subset of building materials from database 801. In other words, the supplier curation engine 802 filters the building materials from database 801 to provide information regarding those building materials that may be available for a specific building project, taking into account what the suppliers can provide at that time or at the time such building materials are needed for the house and customary constructions methods for the available building materials.

In some embodiments, the supplier curation engine 802 selects available building supplies for an individual building project, at various levels of a customizable, hierarchical structure aligned to how the suppliers manage their businesses (e.g., obtain and maintain inventory, package and ship supplies, handle payments, etc.). In some embodiments, they are customizable because a builder is able to set their own preferences and what they make available for construction of certain plans (based on, e.g., preferred vendors, cost considerations for price points, etc.). As an example, one builder might organize all their projects into two groups, Standard and Premium, and want to default building materials and construction methods based on those, while another builder might always build in communities, and manage those tied to the community in which the house is being built. In either case, the customizable hierarchical structure allows the builder to set up the hierarchy, managed preferences at any of those levels. On the supplier side, the hierarchy is usually geographically, but may include separation by line-of-business as well. For example, in some embodiments, the supplier curation engine 802 uses the supplier hierarchy to take into account the region, area and market associated with an individual construction project to determine the building suppliers that can be supplied by suppliers for the individual building project. While region, area, and market are examples of one supplier's geographical hierarchy, another might have “divisior”, “state”, “metro area”, etc. In some other embodiments, the supplier hierarchy takes into account one or more of the region, area and market associated with an individual building project and the manner in which each supplier operates their business to determine the building suppliers that can be supplied by suppliers for the specific building project.

In some embodiments, the hierarchical management sub-system includes a builder (e.g., homebuilder) curation engine 803 communicably coupled to access and receive data from database 801. In some embodiments, the homebuilder curation engine 803 comprises software instructions (e.g., application software and/or system software, such as firmware) stored on a memory (e.g., memory 204) accessible to one or more processors (e.g., processor 202). These software instructions, when executed by a processor, allow the builder curation engine 803 to curate which materials that the builder wants to offer and which construction methods builder uses for the specific type of building project (e.g., building a home, etc.). The builder's preferred construction methods can be their preferred construction methods based on skills set of the crew and/or subcontractors to be used on the building project and their availability during the time of the project.

In some embodiments, the builder curation engine 803 selects materials that the builder wants to offer and construction methods for a specific building project, at various levels of a customizable, hierarchical structure aligned to how the suppliers manage their business. For example, in some embodiments, the builder curation engine 803 uses the homebuilder hierarchy to take into account the region, area and market associated with the specific building project to determine the materials that the homebuilder wants to offer and construction methods for the individual building project. In some other embodiments, the builder hierarchy takes into account one or more of the region, area and market associated with an individual building project and the manner in which the builder operates their business to determine the building supplies that can be supplied by suppliers for the specific building project.

In some embodiments, a hierarchical management sub-system includes a computational engine 804 to receive the outputs of the supplier curation engine 802 and the builder curation engine 803 and process that information to generate a group of building materials and construction methods that will be available for a specific building project, given it's time, location, and selected suppliers (e.g., supplier selected when builder choses the supplier, which could be part of builder curaion engine 803, when builders are selecting both the materials and distributor partners they would like to use though these selections do not have to occur at the same time). In some embodiments, computational engine 804 comprises software instructions (e.g., application software and/or system software, such as firmware) stored on a memory (e.g., memory 204) accessible to one or more processors (e.g., processor 202). These software instructions, when executed by a processor, allow the computational engine 804 to generate the group of materials and construction methods available for the specific building project.

In some embodiments, the computational engine 804 determines and outputs the intersection 807 between those materials that suppliers can provide for a specific building project and those preferred by the builder in view of the builder's preferred construction methods (or their construction capabilities) for the type of building project. The intersection 807 can be accomplished by stacking filters (e.g., filtering the results from one and then filtering those filtered results with another filter, etc.) and computing the intersection. This intersection of information can then be used for generating a material list, modeling and visualization of the building project, building project material list generation, supplier bidding of the building project, ordering of the supplies for the specific building project, and/or the scheduling of the building project.

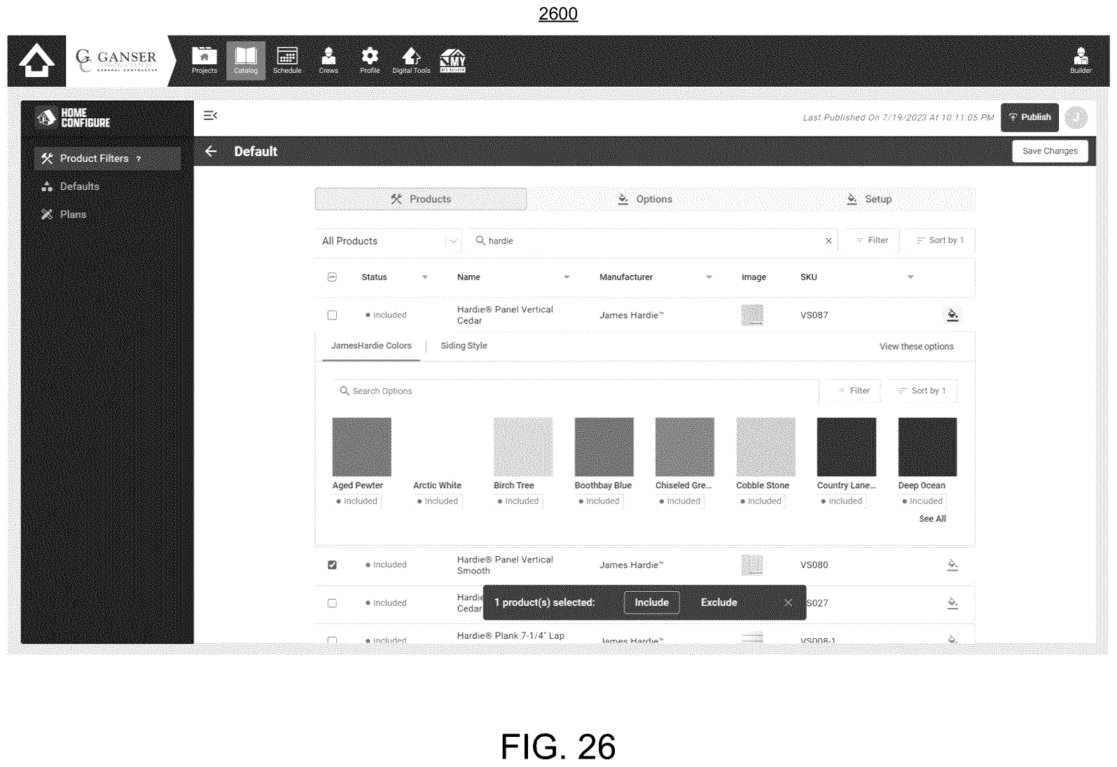

In some embodiments, the computational engine 804 generates a user interface to display the intersection 807, or portions thereof. The user interface can indicate options for selection and/or selections by the homebuilder, their suppliers and subcontractors, as well as the homebuyer. FIG. 26 illustrates an example of one page of such a user interface.

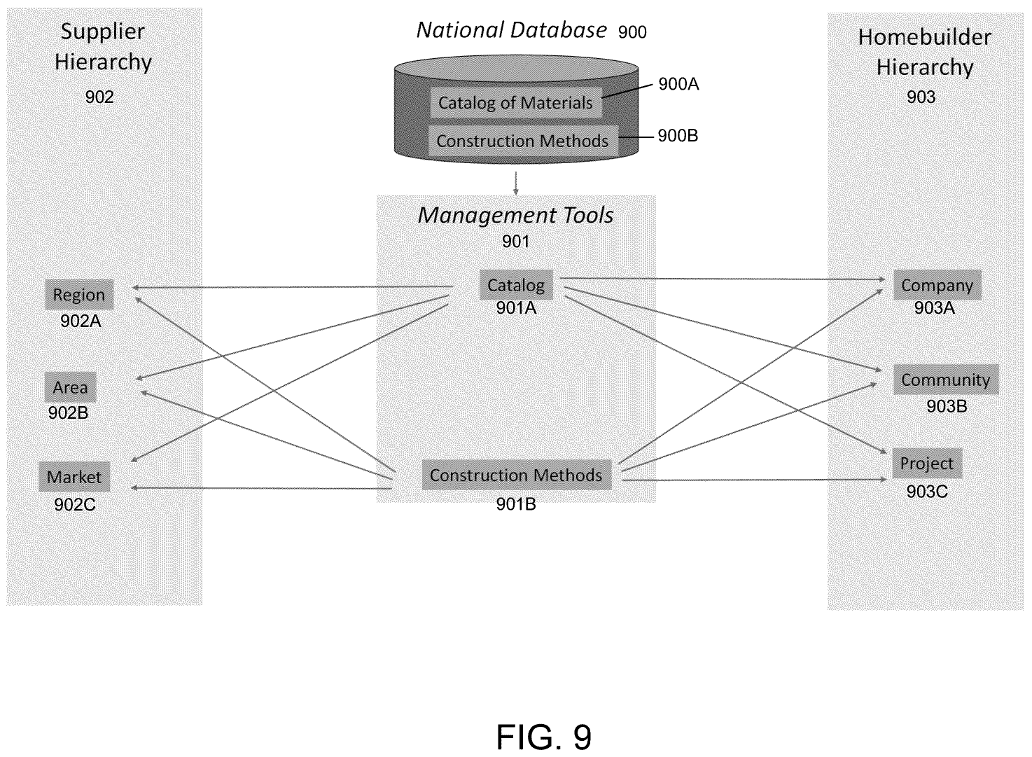

FIG. 9 illustrates some embodiments of hierarchical management sub-system of building materials and construction methods. Referring to FIG. 9, a national database 900 includes a catalog of building materials 900A and a description (e.g., listing, etc.) of construction methods. The management engine 901 is coupled to access the national database 900 to obtain information on building materials and construction methods to create a catalog 901A and a group of construction methods 901B for a specific building project. In some embodiments, the management engine 901 accesses the supplier hierarchy 902, with its specific information related to region 902A, area 902B, and market 902C, to filter information from national database 900 to determine the building supplies that can be supplied by suppliers for the individual building project. In some embodiments, the management engine 901 access the homebuilder hierarchy 903, with its specific information related to company 903A, community 903B, and project 903C to filter information from national database 900 to determine the materials that the homebuilder wants to offer and construction methods for the specific building project. In some embodiments, the management engine 901 includes the curation engines and other components of the hierarchical management sub-system of FIG. 8. These can be displayed on an example user interface. Such an interface can indicate options for selection and/or selections (e.g., the user interface of FIG. 26).

Using the information obtained from the national database 900, the supplier hierarchy 902, and the homebuilder hierarchy 903, the management engine 901 generates a group of materials and construction methods that will be available for the specific building project, given it's time, location, and selected suppliers.

Referring back to FIG. 8, in some embodiments, the hierarchical management sub-system includes a user interface 805 for individuals (e.g., homebuyers, etc.) to make building material selections (e.g., final building material selections based on curated supplies of suppliers and the homebuilder construction methods for building a home) and/or visualizing the end result of specific building project (e.g., a home for a homebuyer, etc.). In some embodiments, the hierarchical management sub-system includes a user interface 806 for homebuilders to make construction method and/or non-visualized material selections (e.g., final selections, etc.). In response to these selections, the hierarchical management sub-system computes and displays the impact to the schedule and costs for the specific building project. These interface can be generated by the hierarchical management sub-system using interface generation circuitry (e.g., interface generation circuitry 208, etc.).

In some embodiments, the hierarchical management sub-system includes a tracking and management sub-system 808 for continuing and repeating the curation and selection processes, along with their associated schedule and cost impacts implications, through the completion of the specific building project.

As described above, example embodiments provide methods and apparatuses that enable improved builder project management and thus provide new and innovative tools that overcome the problems faced by builders when managing multiple building projects via a builder project management user interface. As these examples all illustrate, example embodiments contemplated herein provide technical solutions that solve real-world problems faced during management of building projects.

FIGS. 4-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing presentation, by communications hardware, of a builder project management user interface (UI);
receiving, by the communications hardware, a blueprint dataset for a structure;
classifying, by classifier circuitry and using a classifier model, portions of the blueprint dataset;
generating, by modeling circuitry and using one or more models, digitized feature datasets for the classified portions of the blueprint dataset based on processing of the classified portions of the blueprint dataset by the one or more models;
generating, by a material calculation engine and based on the digitized feature datasets, one or more material pack datasets; and
causing presentation, by the communications hardware, of a visual representation of the one or more material pack datasets via the builder project management UI.

2. The method of claim 1, further comprising:
pre-processing, by input analysis circuitry, the blueprint dataset prior to classifying the portions of the blueprint dataset.

3. The method of claim 2, wherein pre-processing the blueprint dataset comprises:
converting, by the input analysis circuitry, the blueprint dataset from a first file format to a second file format.

4. The method of claim 3, wherein the second file format comprises a rasterized image file format.

5. The method of claim 1, further comprising:
receiving, by the communications hardware and prior to generating the one or more material pack datasets, one or more updated digitized feature datasets; and
causing, by the modeling circuitry, re-training of at least one of the one or more models based on the updated digitized feature datasets,
wherein the one or more material pack datasets are generated based further on the one or more updated digitized feature datasets.

6. The method of claim 5, wherein a respective material pack dataset comprises data representing materials needed for building a portion of the structure associated with a respective digitized feature dataset.

7. The method of claim 1, further comprising:
generating, by three-dimensional modeling circuitry, a three-dimensional (3D) model of the structure based on the digitized feature datasets; and
causing presentation, by the communications hardware, of the 3D model of the structure via the builder project management UI.

8. The method of claim 1, wherein the digitized feature datasets comprise line and measurement data for respective portions of the blueprint dataset.

9. The method of claim 8, wherein generating the one or more material pack datasets comprises:
determining, by the material calculation engine and using one or more optimized subroutines, an optimal amount of material needed for a respective portion of the structure based on the line and measurement data.

10. The method of claim 1, wherein generating the one or more material pack datasets comprises:
assigning, by the material calculation engine and for a respective digitized feature set, a base stock keeping unit (SKU) to each material needed for building a portion of the structure; and
mapping, by the material calculation engine, the base SKU to one or more supplier SKUs based on a user preference set.

11. The method of claim 1, further comprising:
applying, by supplier bid circuitry, pricing information to the one or more material pack datasets based on supplier inventory data.

12. The method of claim 11, further comprising:
receiving, by the communications hardware, a user order indication of at least one material pack dataset via the builder project management UI, wherein the user order indication comprises a requested delivery date;
executing, by ordering circuitry, an order of materials associated with the at least one material pack dataset;
scheduling, by a scheduling engine, a delivery of the order of materials based at least on the requested delivery date; and
causing presentation, by the communications hardware, of a visual representation of an order status for the at least one material pack dataset.

13. The method of claim 12, wherein causing presentation of the visual representation of the one or more material pack datasets via the builder project management UI comprises simultaneously displaying order statuses of the one or more material pack datasets within the builder project management UI.

14. The method of claim 12, further comprising:
generating, by a scheduling engine, a recommended delivery schedule for materials associated with one or more material pack datasets based on the blueprint dataset and builder profile information associated with the received blueprint dataset.

15. The method of claim 14, wherein the recommended delivery schedule is generated based further on one or more parameters, the parameters including: forecasted weather data, regional building practice and code information, calendar event data, supplier restriction data, and builder restriction data.

16. A project management framework comprising:
a database containing building materials and construction methods;
a supplier curation engine communicably coupled to the database to curate information from the database to generate a first list of building materials one or more suppliers have available for a building project and what construction methods, taking into account a manner in which each of the suppliers operates their business;
a builder curation engine communicably coupled to the database to curate information from the database to generate a second list of building materials a builder was to offer for the building project and which construction methods are associated with one or more building materials on the second list, taking into account a manner in which the builder operates their business; and
a computational engine to generate a third list of building materials for the project based on the intersection of the first and second lists based on time, location and selected suppliers for the building project.

17. The project management framework of claim 16 wherein supplier curation engine operates as part of a supplier hierarchy that has a hierarchical structure with building material availability and customary construction methods determinable according to region, area, and market.

18. The project management framework of claim 16 wherein builder curation engine operates as part of a builder hierarchy that has a hierarchical structure with building material availability and customary construction methods determinable according company, community and project.

19. The project management framework of claim 16 further comprising a user interface to enable a builder to select one or more building materials for the building project from the third list.

20. The project management framework of claim 16 further comprising a user interface to enable a homebuyer to select one or more building materials for the building project from the third list and see a visualization of the building project with their selected one or more building materials.
